(19) United States
(12) Patent Application Publication
(10) Pub. No.: US 2024/0174784 A1
(43) Pub. Date: May 30, 2024

(54) POLYMER LATEX COMPOSITION

(71) Applicant: Synthomer Sdn. Bhd., Johor Darul Takzim (MY)

(72) Inventors: Zhenli Wei, Johor Darul Takzim (MY); Yi-Fan Goh, Johor Darul Takzim (MY); Chi Hoong Chan, Johor Darul Takzim (MY)

(73) Assignee: Synthomer Sdn. Bhd., Johor Darul Takzim (MY)

(21) Appl. No.: 18/284,191

(22) PCT Filed: Mar. 29, 2022
(86) PCT No.: PCT/MY2022/050019

§ 371 Date: Sep. 26, 2023

(30) Foreign Application Priority Data
Apr. 7, 2021 (MY) PI 2021001909

(51) Int. Cl. C08F 236/06; C08F 2/22; C08J 5/18; C08L 9/04; C08L 47/00

(52) U.S. Cl. CPC C08F 236/06; C08F 2/22; C08J 5/18; C08L 9/04; C08L 47/00; C08J 2309/04; C08L 2203/16

(57) ABSTRACT

The present invention relates to a polymer latex composition, to a method for the preparation of such polymer latex composition, to a compounded latex composition comprising said polymer latex composition, to the use of said polymer latex composition, to a method for making dip-molded articles, to a method for the production of a continuous elastomeric film and for making an elastomeric article, to a method for repairing or reforming an elastomeric film or an article and to articles made by using said polymer latex composition.

The present invention relates to a polymer latex composition, to a method for the preparation of such polymer latex composition, to a compounded latex composition comprising said polymer latex composition, to the use of said polymer latex composition, to a method for making dip-molded articles, to a method for the production of a continuous elastomeric film and for making an elastomeric article, to a method for repairing or reforming an elastomeric film or an article and to articles made by using said polymer latex composition.

### BACKGROUND OF THE INVENTION

In the art of making articles based on a polymer latex it is in general desired to achieve a high tensile strength and at the same time high elongation of the film forming the article to provide high mechanical strength and desired softness to the article.

In the recent past it was discovered that a growing number of persons show allergic reactions to latex based articles, for example a natural rubber latex that has been used commonly in the past in the manufacturing of latex products such as dip molded product containing up to 5% of non-rubber components such as proteins, lipids and trace elements. Users of natural rubber latex products have developed Type-I hypersensitivity which is caused by the residual extractable latex proteins present in natural rubber products.

Natural as well as artificially made polymer latices are commonly crosslinked using a sulfur vulcanization system including sulfur and sulfur-containing accelerators. The use of these sulfur vulcanization systems in rubber gloves manufacturing can give rise to the delay Type-IV hypersensitivity such as allergic contact dermatitis.

As a result, it is desirable to avoid sulfur vulcanization systems and particularly to provide polymer latices that can be used for the manufacture of dip-molded articles that do not need the standard sulfur vulcanization systems including the sulfur-containing accelerators previously used therein in order to obtain the desired mechanical properties of the final product.

It is further an object of the present invention to provide polymer latex compositions that can be cured at lower temperatures and shorter curing times, for example, for the manufacture of gloves.

Furthermore, there is a desire in the industry for elastomeric films that have inherent self-healing properties and can potentially be recycled in order to reduce the non-usable waste of such elastomeric films and to avoid final failure of articles comprising such elastomeric films.

Therefore, it is an objective of the present invention to provide a polymer latex composition to provide an elastomeric film obtained from said polymer latex composition repairable and recyclable.

### SUMMARY OF THE INVENTION

The following clauses summarize some aspects of the present invention.

According to a first aspect, the present invention relates to a polymer latex composition for producing an elastomeric film comprising particles of a latex polymer (A) obtained by free-radical emulsion polymerization of a mixture of ethylenically unsaturated monomers comprising a conjugated diene and 0.05 to 20 wt.-% of an ethylenically unsaturated acetoacetoxy and/or an acetoacetamido compound (I), preferably an ethylenically unsaturated acetoacetoxy compound (I), wherein the weight percentage of said ethylenically unsaturated acetoacetoxy and/or acetoacetamido compound (I) is based on the total weight of the monomers in the monomer mixture.

The polymer latex composition may further comprise a crosslinking compound (B). The crosslinking compound (B) preferably is reactive with the acetoacetoxy and/or acetoacetamido groups of the particles of a latex polymer (A).

The ethylenically unsaturated acetoacetoxy and/or acetoacetamido compound (I) may have the following structure:

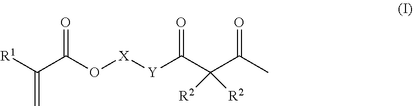

wherein R¹ is selected from hydrogen, or a hydrocarbyl group such as methyl;
wherein X is a linear or a branched C₁-C₂₀ alkanediyl, a cyclic C₃-C₂₀ alkyl, alkenyl or arylenediyl, preferably a linear C₁-C₂₀ alkanediyl;
wherein Y is O or NH, but is preferably O and
wherein each R² independently is a hydrogen or a hydrocarbyl group such as methyl.

The ethylenically unsaturated acetoacetoxy compound (I) may have the following structure:

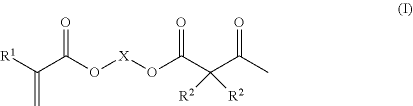

wherein R¹ is selected from hydrogen, or a hydrocarbyl group such as methyl; wherein X is a linear or a branched C₁-C₂₀ alkanediyl, a cyclic C₃-C₂₀ alkyl, alkenyl or arylenediyl, preferably a linear C₁-C₂₀ alkanediyl; and wherein each R² independently is a hydrogen or a hydrocarbyl group such as methyl.

The ethylenically unsaturated acetoacetoxy and/or acetoacetamido compound (I) may be selected from ethylene glycol monoacetoacetate monomethacrylate; acetoacetoxyethyl (meth)acrylate; acetoacetoxypropyl (meth)acrylate; allyl acetoacetate; acetoacetoxybutyl (meth)acrylate; 2,3-di(acetoacetoxy)propyl (meth)acrylate; acetoacetoxy(methyl)ethyl to (meth)acrylate; acetoacetamido-ethyl(meth)acrylate; 3-(methacryloyloxy)-2,2-dimethylpropyl 3-oxobutanoate; 3-(methacryloyloxy)-2,2,4,4-tetramethylcyclobutyl 3-oxobutanoate, such as 3-(methacryloyloxy)-2,2,4-trimethylpentyl 3-oxobutanoate, 1-(methacryloyloxy)-2,2,4-trimethylpentan-3-yl 3-oxobutanoate or mixtures thereof; (4-(methacryloyloxymethyl)cyclohexyl)methyl 3-oxobutanoate or mixtures thereof.

The crosslinking compound (B) may be selected from one or more of:
(I) a metal oxide and/or a metal salt, preferably present in an amount of 0.05 to 10 wt.-%, more preferably 0.5 to 2 wt.-%,
(II) polyamine crosslinker, preferably present in an amount of 0.05 to 20 wt.-%, more preferably 0.05 to 10 wt.-%, and
(III) polyfunctional crosslinker, preferably present in an amount of 0.05 to 20 wt.-%, more preferably 0.05 to 10 wt.-%, having the structure

X—R—Y

wherein R is a linear or a branched C₁-C₂₀ alkanediyl, a cyclic C₃-C₂₀ alkyl, alkenyl or arylenediyl;
wherein X is a first functional group reactive with the acetoacetoxy and/or acetoacetamido group of the particles of a latex polymer (A) and Y is a second functional group reactive with the acetoacetoxy and/or acetoacetamido group or a carboxyl group of the particles of a latex polymer (A), preferably the first functional group is selected from primary amine, secondary amine, hydrazide, isocyanate, or aldehyde and the second function group is selected from primary amine, secondary amine, aldehyde, epoxy, imine, hydroxyl, hydrazide, hydrazine, isocyanate, or halide;
wherein the weight percentages are based on the total weight of the particles of a latex polymer (A).

The metal oxide (I) may be selected from divalent, trivalent or tetravalent metal oxides such as zinc oxide, titanium dioxide, magnesium oxide, iron oxide, aluminium oxide, sodium aluminate, sodium stannate, and combinations thereof.

The metal salt (I) may be selected from aluminium sulfate, aluminium chloride, aluminium hydroxide, aluminium nitrate, and combinations thereof.

The polyamine crosslinker (II) may be selected from 1,2-diamino ethane, 1,6-diamino hexane, phenylene diamine, tris(2-aminoethyl)amine, polyallyl amine, benzidine, to branched poly(ethylene imine), and combinations thereof.

The polyfunctional crosslinker (III) may be selected from amino hydrazides, amino aldehydes, alkanolamines, amino halides, polyhydrazides, hydrazide aldehydes, halide hydrazides, polyisocyanates, halide isocyanates, polyaldehydes, hydroxy aldehydes, halide aldehydes, and combinations thereof.

The monomer composition to obtain the particles of a latex polymer (A) may further comprise:
(a) 15 to 99 wt.-% of conjugated dienes;
(b) 1 to 80 wt.-% of monomers selected from ethylenically unsaturated nitrile compounds;
(c) 0 to 10 wt.-% of an ethylenically unsaturated acrylic acid and/or salts thereof,
(d) 0 to 80 wt.-% of vinyl aromatic monomers; and
(e) 0 to 65 wt.-% of alkyl esters of ethylenically unsaturated acids,
wherein the weight percentages are based on the total weight of monomers in the monomer mixture.

It is envisaged that
(a) the conjugated dienes may be selected from 1,3-butadiene, isoprene, 2,3-dimethyl-1,3-butadiene, 2-ethyl-1,3-butadiene, 1,3-pentadiene and combinations thereof, preferably 1,3-butadiene;
(b) the ethylenically unsaturated nitrile compounds may be selected from (meth)acrylonitrile, alpha-cyanoethyl acrylonitrile, fumaronitrile, alpha-chloronitrile and combinations thereof;
(c) the ethylenically unsaturated acrylic acid and/or salts thereof may be selected from (meth)acrylic acid, crotonic acid, itaconic acid, maleic acid, fumaric acid, and salts thereof, carboxy alkyl esters of ethylenically unsaturated acids, and combinations thereof;
(d) the vinyl aromatic monomers may be selected from styrene, alpha-methyl styrene and combinations thereof;
(e) alkyl esters of ethylenically unsaturated acids may be selected from methyl (meth)acrylate, ethyl (meth)acrylate, propyl (meth)acrylate, butyl (meth)acrylate, 2-ethylhexyl (meth)acrylate, and combinations thereof;
and combinations thereof;
the mixture of ethylenically unsaturated monomers for latex polymer (A) may optionally comprise ethylenically unsaturated monomers selected from
(f) vinyl carboxylates, preferably vinyl acetate, vinyl propionate, vinyl butyrate, vinyl to benzoate, vinyl-2-ethylhexanoate, vinyl stearate, vinyl esters of versatic acid, and combinations thereof;
(g) monomers having at least two identical ethylenically unsaturated groups,
preferably selected from divinyl benzene, ethylene glycol dimethacrylate, 1,4 butanediol di(meth)acrylate, and combinations thereof;
and combinations thereof.

The mixture of ethylenically unsaturated monomers to obtain the particles of a latex polymer (A) may comprise:
20 to 99 wt.-% of conjugated dienes, preferably selected from 1,3-butadiene, isoprene and combinations, thereof, more preferred 1,3-butadiene;
0.05 to 10 wt. % of an ethylenically unsaturated acetoacetoxy and/or acetoacetamido compound (I), preferably an ethylenically unsaturated acetoacetoxy compound (I);
1 to 60 wt.-% of monomers selected from ethylenically unsaturated nitrile compounds, preferably acrylonitrile;
0 to 70 wt.-% of vinyl aromatic monomers, preferably styrene;
0 to 25 wt.-% of C₁ to C₈ alkyl (meth)acrylates;
0 to 10 wt.-%, preferably 0.05 to 7 wt.-% of ethylenically unsaturated acids, preferably (meth)acrylic acid;
0 to 10 wt.-% of vinyl esters:
wherein the weight percentages are based on the total weight of monomers in the monomer mixture.

The particles of a latex polymer (A) may be free of (meth)acrylic acid.

The pH value of the polymer latex composition may be from 6.5 to 9.0, such as from 6.5 to 7.0, and may be adjusted using a pH modifier selected from sodium hydroxide, potassium hydroxide, ammonia solution, preferably ammonia solution.

The particles of a latex polymer (A) may be present in amounts of 75 to 99.8 wt.-%, preferably 78 to 99.5 wt.-%, more preferably 80 to 99 wt.-%, most preferably 82 to 98 wt.-% and/or the crosslinking compound (B) may be present in an amount of 0.02 to 25 wt.-%, preferably 0.05 to 22 wt.-%, more preferably 0.5 to 20 wt.-%, most preferably 1.0 to 18 wt.-% in the polymer latex composition, wherein the weight percentages are based on the total solids weight of the polymer latex composition.

The particles of a latex polymer (A) may be pre-crosslinked obtained by reacting the particles of a latex polymer (A) with 0.05 to 5 wt.-% of the polyamine crosslinker (II) and/or 0.05 to 5 wt.-% of the polyfunctional crosslinker (III), wherein the weight to percentages are based on the total weight of the particles of a latex polymer (A).

According to a further aspect, the invention relates to a compounded polymer latex composition suitable for the production of dip-molded articles comprising the polymer latex composition as discussed, wherein the polymer latex composition further comprises adjuvants selected from sulfur vulcanization agents, accelerators for sulfur vulcanization and combinations thereof or the polymer latex composition as discussed is free of sulfur vulcanization agents and accelerators for sulfur vulcanization.

The pH value of the compounded polymer latex may be from 8.0 to 12.0, such as from 9.0 to 11.5, and may be adjusted using a pH modifier selected from sodium hydroxide, potassium hydroxide, ammonia solution, preferably potassium hydroxide.

The compounded polymer latex composition may comprise initiators, antifoams, waxes, surfactants, antioxidants, stabilizers, fillers, pigments, and combinations thereof.

Another aspect of the present invention relates to a method for the preparation of the polymer latex composition as discussed, comprising:
a) polymerizing in an emulsion polymerization process a composition comprising a mixture of ethylenically unsaturated monomers comprising a conjugated diene and 0.05 to 20 wt.-% of an ethylenically unsaturated acetoacetoxy and/or acetoacetamido compound (I), preferably an ethylenically unsaturated acetoacetoxy compound (I), wherein the weight percentage of said ethylenically unsaturated acetoacetoxy and/or acetoacetamido compound (I) is based on the total weight of monomers in the monomer mixture to obtain particles of a latex polymer (A),
b) optionally pre-crosslinking the particles of a latex polymer (A) using 0.05 to 5 wt.-% of a polyamine crosslinker (II) and/or 0.05 to 5 wt.-% of a polyfunctional crosslinker (III), wherein the weight percentage is based on the total weight of the particles of a latex polymer;
c) optionally mixing the particles of a latex polymer (A) with a crosslinking compound (B).

Another aspect of the present invention relates to use of the polymer latex composition as discussed for the production of dip-molded articles, an elastomeric film, a self-supporting elastomeric film or article or for coating or impregnating a substrate, preferably a textile substrate.

In addition, according to a further aspect of the present invention, the invention relates to a method for making dip-molded articles by
a) providing a compounded polymer latex composition as described;
b) immersing a mold having the desired shape of the final article in a coagulant bath comprising a solution of a metal salt;
c) removing the mold from the coagulant bath and optionally drying the mold;
d) immersing the mold as treated in step b) and c) in the compounded latex composition of step a);
e) coagulating a latex film on the surface of the mold;
f) removing the latex-coated mold from the compounded latex composition and optionally immersing the latex-coated mold in a water bath;
g) optionally drying the latex-coated mold;
h) heat treating the latex-coated mold obtained from step e) or f) at a temperature of 40° C. to 200° C. preferably for 20 min or less; and/or UV treating; and
i) removing the latex article from the mold.

Another aspect of the present invention relates to a method for the production of a continuous elastomeric film comprising:
(A) providing a polymer latex composition as described;
(B) forming from the polymer latex composition a continuous polymer film;
(C) optionally drying the continuous polymer film obtained in step B);
(D) heat treating the continuous polymer film obtained in step B) or C) at a temperature of 40° C. to 180° C. preferably for 20 min or less to form a continuous elastomeric film; and/or UV treating; and
(E) optionally rolling the continuous elastomeric film obtained in step D) into a roll.

The heat treating of the method for making dip-molded articles and/or the method for the production of a continuous elastomeric film may be carried out at a temperature of 60 to 175 ° C. for 1 sec to 20 min, preferably at a temperature of 95 to 135 ° C. for 5 sec to 5 min.

Furthermore, according to another aspect the invention relates to a process for making an elastomeric article by
aligning two separate continuous elastomeric films obtained as described;
cutting the aligned continuous elastomeric films into a preselected shape to obtain two superposed layers of the elastomeric films in the preselected shape; and
joining together the superposed layers of elastomeric film at least a preselected part of the periphery of the superposed layers to form an elastomeric article.

The joining of the process for making an elastomeric article together may be performed by using thermal means, preferably selected from heat sealing and welding or by gluing.

The cutting of the process for making an elastomeric article may be performed by a heatable template cutting device or laser cutter, providing the preselected shape and the to cutting device may be heated in the sections that contact the elastomeric films where the films are joined together, thereby simultaneously cutting the elastomeric films into the preselected shape and heat sealing the preselected parts of the periphery of the superposed elastomeric films.

Another aspect of the present invention relates to a method for repairing or reforming an elastomeric film or an article comprising said elastomeric film by
a) providing a film or article comprising an elastomeric film or films, having at least two surfaces to be reconnected,
b) re-joining the at least two surfaces of the elastomeric film(s), and
c) heating or annealing the elastomeric film(s) while maintaining intimate contact of the rejoined surfaces of the damaged film at a temperature of 40 to 200 ° C., preferably 60 to 175 ° C., more preferably 95 to 135 ° C., wherein the elastomeric film is made from a polymer latex composition as described, wherein the elastomeric film comprises enaminone crosslinks between the particles of the latex polymer.

A further aspect of the present invention relates to an article made by using the polymer latex composition as described or obtained as described.

The article may be selected from surgical gloves, examination gloves, industrial gloves, household gloves, single-use gloves, textile supported gloves, catheters, elastomeric sleeves, condoms, balloons, tubing, dental dam, apron and pre-formed gasket.

### DETAILED DESCRIPTION OF THE INVENTION

The present invention relates to a polymer latex composition comprising particles of a latex polymer (A) obtained by free-radical emulsion polymerization of a mixture of ethylenically unsaturated monomers comprising a conjugated diene and 0.05 to 20 wt.-% of an ethylenically unsaturated acetoacetoxy and/or acetoacetamido compound (I), preferably an ethylenically unsaturated acetoacetoxy compound (I). The weight percentage of said ethylenically unsaturated acetoacetoxy and/or acetoacetamido compound (I) is based on the total weight of the monomers in the monomer mixture. The polymer latex composition of the present invention is suitable for producing an elastomeric film.

The acetoacetoxy-functional and the acetoacetamido-functional monomers (I) employed in the polymer latex formulation of this invention exhibit the ability to crosslink via a self-curing “oxidative cure”, react with an added crosslinking compound, or cure using ultraviolet (UV) light with or without the addition of photo-initiators.

### Latex Polymer (A)

The latex polymer (A) to be used according to the present invention can be prepared by any suitable free-radical emulsion polymerization process known in the art. Suitable process parameters are those that will be discussed below.

The ethylenically unsaturated monomers to be used for the preparation of the latex polymer (A) and their relative amounts are not particularly critical as long as the monomer mixture comprises a conjugated diene and an ethylenically unsaturated acetoacetoxy and/or acetoacetamido compound (I), preferably an ethylenically unsaturated acetoacetoxy compound (I). Monomer compositions additionally comprising ethylenically unsaturated nitrile compounds are particularly useful, e.g., for dip-molding applications.

The ethylenically unsaturated acetoacetoxy compound (I) of the invention may be prepared, for example, by reacting a suitable glycol with a diketene delivering reagent such as tert-butyl acetoacetate or 2,2,6-trimethyl-4H-1,3-dioxin-4-one (TKD), the diketene-acetone adduct, to provide the acetoacetoxy moiety followed by reaction with a reagent such as (meth)acrylic anhydride to provide the ethylenically unsaturated moiety. Alternatively, the ethylenically unsaturated acetoacetoxy compound may be prepared by first reacting a glycol with a reagent such as (meth)acrylic anhydride to provide the ethylenically unsaturated moiety followed by reaction with diketene or a diketene delivering agent such as tert-butyl acetoacetate or the diketene-acetone adduct (TKD) to provide the acetoacetoxy moiety. A suitable synthesis of ethylenically unsaturated acetoacetoxy compounds (I) is described in WO 2012/082348 A1.

According to the present invention, the ethylenically unsaturated acetoacetoxy and/or acetoacetamido compound (I) may have the following structure:

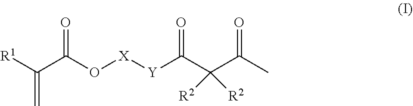

wherein R¹ is selected from hydrogen, or a hydrocarbyl group such as methyl; X is a linear or a branched C₁-C₂₀ alkanediyl, a cyclic C₃-C₂₀ alkyl, alkenyl or arylenediyl, preferably a linear C₁-C₂₀ alkanediyl; Y is O or NH, and is preferably O; and each R² independently is a hydrogen or a hydrocarbyl group such as methyl. The hydrocarbyl group may be selected from a linear or branched C₁-C₄ alkanediyl. Preferably, R¹ is selected from hydrogen or methyl.

The ethylenically unsaturated acetoacetoxy compound (I) may have the following structure:

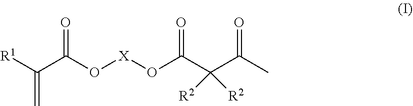

wherein R¹ is selected from hydrogen, or a hydrocarbyl group such as methyl; X is a linear or a branched C₁-C₂₀ alkanediyl, a cyclic C₃-C₂₀ alkyl, alkenyl or arylenediyl, preferably a linear C₁-C₂₀ alkanediyl; and each R² independently is a hydrogen or a hydrocarbyl group such as methyl. The hydrocarbyl group may be selected from a linear or branched C₁-C₄ alkanediyl. Preferably, R¹ is selected from hydrogen or methyl.

Suitable ethylenically unsaturated acetoacetoxy and/or acetoacetamido compounds (I) may be selected from ethylene glycol monoacetoacetate monomethacrylate; acetoacetoxyethyl (meth)acrylate; acetoacetoxypropyl (meth)acrylate; allyl acetoacetate; acetoacetoxybutyl (meth)acrylate; 2,3-di(acetoacetoxy)propyl (meth)acrylate; acetoacetoxy(methyl)ethyl (meth)acrylate; acetoacetamido-ethyl(meth)acrylate; 3-(methacryloyloxy)-2,2-dimethylpropyl 3-oxobutanoate; 3-(methacryloyloxy)-2,2,4,4-tetramethylcyclobutyl 3-oxobutanoate, such as 3-(methacryloyloxy)-2,2,4-trimethylpentyl 3-oxobutanoate, 1-(methacryloyloxy)-2,2,4-trimethylpentan-3-yl 3-oxobutanoate or mixtures thereof; (4-(methacryloyloxymethyl)cyclohexyl)methyl 3-oxobutanoate or mixtures thereof.

Suitable ethylenically unsaturated acetoacetoxy compounds (I) may be selected from ethylene glycol monoacetoacetate monomethacrylate; acetoacetoxyethyl (meth)acrylate; acetoacetoxypropyl (meth)acrylate; allyl acetoacetate; acetoacetoxybutyl (meth)acrylate; 2,3-di(acetoacetoxy)propyl (meth)acrylate; acetoacetoxy(methyl)ethyl (meth)acrylate; 3-(methacryloyloxy)-2,2-dimethylpropyl 3-oxobutanoate; 3-(methacryloyloxy)-2,2,4,4-tetramethylcyclobutyl 3-oxobutanoate, such as 3-(methacryloyloxy)-2,2,4-trimethylpentyl 3-oxobutanoate, 1-(methacryloyloxy)-2,2,4-trimethylpentan-3-yl 3-oxobutanoate or mixtures thereof; (4-(methacryloyloxymethyl)cyclohexyl)methyl 3-oxobutanoate or mixtures thereof.

The amount of the ethylenically unsaturated acetoacetoxy and/or acetoacetamido compounds (I), preferably the ethylenically unsaturated acetoacetoxy compounds (I), in to the monomer mixture to obtain the particles of a latex polymer (A) ranges from 0.05 to 20 wt.-%, such as from 0.1 to 18 wt.-%, or from 0.2 to 16 wt.-%, or from 0.5 to 15 wt.-%, or from 0.8 to 12 wt.-%, or from 1 to 10 wt.-%, or from 1.5 to 8 wt.-%, or from 2 to 6 wt.-%. The weight percentage is based on the total weight of the ethylenically unsaturated monomers in the monomer mixture. The amount of the ethylenically unsaturated acetoacetoxy and/or acetoacetamido compounds (I), preferably the ethylenically unsaturated acetoacetoxy compounds (I), in the monomer mixture to obtain the particles of a latex polymer (A) ranges from 0.05 to 20 wt.-%, preferably from 0.1 to 18 wt.-%, more preferably from 0.5 to 15 wt.-%, even more preferably 1 to 10 wt.-%, most preferably 2 to 6 wt.-%. The weight percentage is based on the total weight of the ethylenically unsaturated monomers in the monomer mixture.

According to the present invention, the monomer mixture to obtain the particles of a latex polymer (A) may further comprise:
(a) 15 to 99 wt.-% of conjugated dienes;
(b) 1 to 80 wt.-% of monomers selected from ethylenically unsaturated nitrile compounds;
(c) 0 to 10 wt.-% of an ethylenically unsaturated acrylic acid and/or salts thereof,
(d) 0 to 80 wt.-% of vinyl aromatic monomers; and
(e) 0 to 65 wt.-% of alkyl esters of ethylenically unsaturated acids,
wherein the weight percentages are based on the total weight of the ethylenically unsaturated monomers in the monomer mixture.

Conjugated diene monomers suitable for the preparation of particles of a latex polymer (A) according to the present invention may include conjugated diene monomers selected from 1,3-butadiene, isoprene, 2,3-dimethyl-1,3-butadiene, 2,3-dimethyl-1,3-butadiene, 2-chloro-1,3-butadiene, 1,3-pentadiene, 1,3-hexadiene, 2,4-hexadiene, 1,3-octadiene, 2-methyl-1,3-pentadiene, 2,3-dimethyl-1,3-pentadiene, 3,4- dimethyl-1,3-hexadiene, 2,3-diethyl-1,3-butadiene, 4,5-diethyl-1,3-octadiene, 3-butyl-1,3-octadiene, 3,7-dimethyl-1,3,6-octatriene, 2-methyl-6-methylene-1,7-octadiene, 7-methyl-3-methylene-1,6-octadiene, 1,3,7-octatriene, 2-ethyl-1,3-butadiene, 2-amyl-1,3-butadiene, 3,7-dimethyl-1,3,7-octatriene, 3,7-dimethyl-1,3,6-octatriene, 3,7,11-trimethyl-1,3,6,10-dodecatetraene, 7,11-dimethyl-3-methylene-1,6,10-dodecatriene, 2,6-dimethyl-2,4,6-octatriene, 2-phenyl-1,3-butadiene, 2-methyl-3-isopropyl-1,3-butadiene and 1,3-cyclohexadiene and combinations thereof, preferably 1,3-butadiene, isoprene, 2,3-dimethyl-1,3-butadiene, 2-ethyl-1,3-butadiene, 1,3-pentadiene, and combinations thereof. 1,3-butadiene, isoprene, 2,3-dimethyl-1,3-butadiene, 2-ethyl-1,3-butadiene, 1,3-pentadiene and combinations thereof are the more preferred conjugated dienes. 1,3-Butadiene is the most preferred diene. Typically, the amount of conjugated diene monomer ranges from 15 to 99 wt.-%, preferably from 20 to 95 wt.-%, more preferably from 30 to 75 wt.-%, most preferably from 40 to 70 wt.-%, based on the total weight of the ethylenically unsaturated monomers in the monomer mixture. Thus, the conjugated diene may be present in amounts of at least 15 wt.-%, at least 20 wt.-%, at least 22 wt.-%, at least 24 wt.-%, at least 26 wt.-%, at least 28 wt.-%, at least 30 wt.-%, at least 32 wt.-%, at least 34 wt.-%, at least 36 wt.-%, at least 38 wt.-%, or at least 40 wt.-%, based on the total weight of the ethylenically unsaturated monomers in the monomer mixture. Accordingly, the conjugated diene monomers can be used in amounts of no more than 99 wt.-%, no more than 95 wt.-20%, no more than 90 wt.-%, no more than 85 wt.-%, no more than 80 wt.-%, no more than 78 wt.-%, no more than 76 wt.-%, no more than 74 wt.-%, no more than 72 wt.-%, no more than 70 wt.-%, no more than 68 wt.-%, no more than 66 wt.-%, no more than 64 wt.-%, no more than 62 wt.-%, no more than 60 wt.-%, no more than 58 wt.-%, or no more than 56 wt.-%, based on the total weight of the ethylenically unsaturated monomers in the monomer mixture. A person skilled in the art will appreciate that any range between any of the explicitly disclosed lower and upper limit is herein disclosed.

Unsaturated nitrile monomers which can be used in the present invention may include polymerizable unsaturated aliphatic nitrile monomers which contain from 2 to 4 carbon atoms in a linear or branched arrangement, which may be substituted either by acetyl or additional nitrile groups. The ethylenically unsaturated nitrile compounds for the preparation of particles of a latex polymer (A) according to the present invention may be selected from acrylonitrile, methacrylonitrile, alpha-cyanoethyl acrylonitrile, fumaronitrile, alpha-chloronitrile and combinations thereof, with acrylonitrile being most preferred. These nitrile monomers can be included in amounts from 1 to 80 wt.-%, preferably from 10 to 70 wt.-%, or 1 to 60 wt.-%, and more preferred from 15 to 50 wt.-%, even more preferred from 20 to 50 wt.-%, most preferred from 23 to 43 wt.-%, based on the total weight of the ethylenically unsaturated monomers in the monomer mixture.

Thus, the unsaturated nitrile may be present in amounts of at least 1 wt.-%, at least 5 wt.-%, at least 10 wt.-%, at least 12 wt.-%, at least 14 wt.-%, at least 15 wt.-%, at least 16 wt.-%, at least 18 wt.-%, at least 20 wt.-%, at least 22 wt.-%, at least 23 wt.-% at least 24 wt.-%, at least 26 wt.-%, at least 28 wt.-%, at least 30 wt.-%, at least 32 wt.-%, at least 34 wt.-%, at least 36 wt.-%, at least 38 wt.-%, or at least 40 wt.-%, based on the total weight of the ethylenically unsaturated monomers in the monomer mixture. Accordingly, the unsaturated nitrile monomers can be used in amounts of no more than 80 wt.-%, no to more than 75 wt.-%, no more than 73 wt.-%, no more than 70 wt.-%, no more than 68 wt.-%, no more than 66 wt.-%, no more than 64 wt.-%, no more than 62 wt.-%, no more than 60 wt.-%, no more than 58 wt.-%, no more than 56 wt.-%, no more than 54 wt.-%, no more than 52 wt.-%, no more than 50 wt.-%, no more than 48 wt.-%, no more than 46 wt.-%, or no more than 44 wt.-%, no more than 43 wt.-%, based on the total weight of the ethylenically unsaturated monomers in the monomer mixture. A person skilled in the art will appreciate that any range between any of the explicitly disclosed lower and upper limit is herein disclosed.

Suitable ethylenically unsaturated acids and salts thereof (c) may be selected from ethylenically unsaturated carboxylic acid monomers, ethylenically unsaturated sulfonic acid monomers, ethylenically unsaturated phosphorous-containing acid monomers. The ethylenically unsaturated carboxylic acid monomers suitable for use in the present invention include monocarboxylic acid and dicarboxylic acid monomers, monoesters of dicarboxylic acid and carboxy alkyl esters of ethylenically unsaturated acids such as 2-carboxy ethyl (meth)acrylate. Carrying out the present invention, it is preferable to use ethylenically unsaturated aliphatic mono- or dicarboxylic acids or anhydrides which contain from 3 to 5 carbon atoms. Examples of monocarboxylic acid monomers include (meth)acrylic acid, crotonic acid and examples of dicarboxylic acid monomers including fumaric acid, itaconic acid, maleic acid and maleic anhydride. Examples of other suitable ethylenically unsaturated acids include vinyl acetic acid, vinyl lactic acid, vinyl sulfonic acid, 2-methyl-2-propene-1-sulfonic acid, styrene sulfonic acid, acrylamidomethyl propane sulfonic acid and the salts thereof. (Meth)acrylic acid, crotonic acid, itaconic acid, maleic acid, fumaric acid, ethylenically unsaturated sulfonic acids, ethylenically unsaturated phosphorous containing acids and salts thereof, polycarboxylic acid anhydride, polycarboxylic acid partial ester monomer, carboxylic alkyl esters of ethylenically unsaturated acids and combinations thereof are preferred. (Meth)acrylic acid, crotonic acid, itaconic acid, maleic acid, fumaric acid, and salts thereof, carboxylic alkyl esters of ethylenically unsaturated acids and combinations thereof are particularly preferred. According to the present invention, the ethylenically unsaturated acid and/or salts thereof may not comprise (meth)acrylic acid.

Examples of ethylenically unsaturated sulfonic acid monomers include vinylsulfonic acid, phenyl vinylsulfonate, sodium 4-vinylbenzenesulfonate, 2-methyl-2-propene-1-sulfonic acid, 4-styrenesulfonic acid, 3-allyloxy-2-hydroxy-1-propanesulfonic acid, 2-acrylamido-2-methyl-1-propanesulfonic acid and the salts thereof.

Examples of ethylenically unsaturated phosphorus-containing acid monomers include vinylphosphonic acid, dimethyl vinylphosphonate, diethyl vinylphosphonate, diethyl to allylphosphonate, allylphosphonic acid and the salts thereof.

These ethylenically unsaturated acids and salts thereof (c) can be included in amounts from 0 to 10 wt.-%, preferably from 0.05 to 9 wt.-%, more preferably from 0.1 to 8 wt.-%, even more preferably from 0.5 to 7 wt.-%, most preferably from 1 to 7 wt.-%, based on the total weight of the ethylenically unsaturated monomers in the monomer mixture. Thus, the ethylenically unsaturated acids and salts (c) may be present in amounts of at least 0.01 wt.-%, at least 0.05 wt.-%, at least 0.1 wt.-%, at least 0.3 wt.-%, at least 0.5 wt.-%, at least 0.7 wt.-%, at least 0.9 wt.-%, at least 1.0 wt.-%, at least 1.2 wt.-%, at least 1.4 wt.-%, at least 1.6 wt.-%, at least 1.8 wt.-%, at least 2.0 wt.-%, at least 2.5 wt.-%, or at least 3 wt.-%, based on the total weight of the ethylenically unsaturated monomers in the monomer mixture. Likewise, the ethylenically unsaturated compounds (c) may be present in amounts of no more than 10 wt.-%, no more than 9.5 wt.-%, no more than 9 wt.-%, no more than 8.5 wt.-%, no more than 8 wt.-%, no more than 7.5 wt.-%, no more than 7 wt.-%, no more than 6.5 wt.-%, no more than 6 wt.-%, no more than 5.5 wt.-%, or no more than 5 wt.-%, based on the total weight of the ethylenically unsaturated monomers in the monomer mixture. A person skilled in the art will appreciate that any range defined by an explicitly disclosed lower limit and an explicitly disclosed upper limit is disclosed herewith.

Suitable vinyl-aromatic monomers (d) may be selected from styrene, oc-methylstyrene, vinyltoluene, o-methylstyrene, p-methylstyrene, p-tert-butylstyrene, 2,4-dimethylstyrene, 2-methylstyrene, 3-methylstyrene, 4-methylstyrene, 2-ethylstyrene, 3-ethylstyrene, 4-ethylstyrene, 2,4-diisopropylstyrene, 2,4-dimethylstyrene, 4-tert-butylstyrene, 5-tert-butyl-2-methylstyrene, vinylnaphthalene, vinyltoluene, vinylxylene, 2-vinylpyridine, 4-vinylpyridine, 1,1-diphenylethylenes, 1,2-diphenylethene, and combinations thereof. Preferably, vinyl-aromatic monomers (d) may be selected from styrene, oc-methylstyrene, and combinations thereof. The vinyl-aromatic compounds (d) can be used in a range of from 0 to 80 wt.-%, or 0 to 70 wt.-%, or 0 to 50 wt.-%, preferably from 0 to 40 wt.-% more preferred from 0 to 25 wt.-%, even more preferred from 0 to 15 wt.-%, and most preferred from 0 to 10 wt.-%, based on the total weight of the ethylenically unsaturated monomers in the monomer mixture. Thus, the vinyl-aromatic compound (d) can be present in an amount of no more than 80 wt.-%, no more than 75 wt.-%, no more than 60 wt.-%, no more than 50 wt.-%, no more than 40 wt.-%, no more than 35 wt.-%, no more than 30 wt.-%, no more than 25wt.-%, no more than 20 wt.-%, no more than 18 wt.-%, no more than 16 wt.-%, no more than 14 wt.-%, no more than 12 wt.-%, no more than 10 wt.-%, no more than 8 wt.-%, no more than 6 wt.-%, no more than 4 wt.-%, no more than 2 wt.-%, or no more than 1 wt.-%, based on the total weight of the ethylenically unsaturated monomers in the monomer mixture. Vinyl-aromatic compounds (d) may also be completely absent.

Suitable alkyl ester of ethylenically unsaturated acids (e) may be selected from n-alkyl esters, iso-alkyl esters or tert-alkyl esters of (meth)acrylic acid in which the alkyl group has from 1 to 20 carbon atoms as well as the reaction product of methacrylic acid with glycidyl ester of a neoacid such as versatic acid, neodecanoic acid or pivalic acid.

In general, the preferred alkyl esters of (meth)acrylic acids may be selected from C₁-C₁₀ alkyl (meth)acrylate, preferably C₁-C₈ -alkyl (meth)acrylates. Examples of such (meth)acrylate monomers include n-butyl acrylate, secondary butyl acrylate, ethyl acrylate, hexyl acrylate, tert-butyl acrylate, 2-ethyl-hexyl acrylate, isooctyl acrylate, 4-methyl-2-pentyl acrylate, 2-methylbutyl acrylate, methyl methacrylate, tert-butyl methacrylate, n-butyl methacrylate, isobutyl methacrylate, ethyl methacrylate, isopropyl methacrylate, hexyl methacrylate, cyclohexyl methacrylate and cetyl methacrylate. Methyl (meth)acrylate, ethyl (meth)acrylate, propyl (meth)acrylate, butyl (meth)acrylate, 2-ethylhexyl (meth)acrylate and combinations thereof are preferred.

Typically, the alkyl esters of ethylenically unsaturated acids (e) can be present in an amount of no more than 65 wt.-%, no more than 60 wt.-%, no more than 55 wt.-%, no more than 50 wt.-%, no more than 45wt.-%, no more than 40 wt.-%, no more than 35 wt.-%, no more than 30 wt.-%, no more than 25 wt.-%, no more than 20 wt.-%, no more than 18 wt.-%, no more than 16 wt.-%, no more than 14 wt.-%, no more than 12 wt.-%, no more than 10 wt.-%, no more than 8 wt.-%, no more than 6 wt.-%, no more than 4 wt.-%, no more than 2 wt.-%, or no more than 1 wt.-%, based on the total weight of the ethylenically unsaturated monomers in the monomer mixture.

Further, the mixture of ethylenically unsaturated monomers for particles of a latex polymer (A) according to the present invention may include additional ethylenically unsaturated monomers that are different from the above-defined monomers. These monomers may be selected from vinyl carboxylates (f) and/or monomers having two identical ethylenically unsaturated groups (g).

Vinyl carboxylate monomers (f) which can be used according to the present invention include vinyl acetate, vinyl propionate, vinyl butyrate, vinyl benzoate, vinyl-2-ethylhexanoate, vinyl stearate, and the vinyl esters of versatic acid. The most preferred vinyl ester monomer (f) for use in the present invention is vinyl acetate. Typically, the vinyl ester monomers (f) can be present in an amount of no more than 18 wt.-%, no more than 16 wt.-%, no more than 14 wt.-%, no more than 12 wt.-%, no more than 10 wt.-%, no to more than 8 wt.-%, no more than 6 wt.-%, no more than 4 wt.-%, no more than 2 wt.-%, or no more than 1 wt.-%, based on the total weight of the ethylenically unsaturated monomers in the monomer mixture.

Furthermore, monomers having at least two identical ethylenically unsaturated groups (g) can be present in the monomer mixture for the preparation of the polymer latex of the present invention in an amount of 0 to 6.0 wt.-%, preferably 0.1 to 3.5 wt.-%, based on the total weight of the ethylenically unsaturated monomers in the monomer mixture. Typically, these monomers can be present in an amount of no more than 6 wt.-%, no more than 4 wt.-%, no more than 2 wt.-%, no more than 1 wt.-%, based on the total weight of the ethylenically unsaturated monomers in the monomer mixture. Suitable bifunctional monomers (g) which are capable of providing internal crosslinking and branching in the polymer (herein known as multifunctional monomers) may be selected from divinyl benzene and diacrylates and di(meth)acrylates. Examples are ethylene glycol di(meth)acrylate, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, and dipropylene glycol di(meth)acrylate. The monomers having at least two ethylenically unsaturated groups (g) are preferably selected from divinyl benzene, 1,2 ethyleneglycol di(meth)acrylate, 1,4-butanediol di(meth)acrylate and 1,6-hexanediol di(meth)acrylate, and combinations thereof.

According to the present invention, the amounts of the above-defined monomers for the preparation of particles of a latex polymer (A) may add up to 100 wt.-%.

The mixture of ethylenically unsaturated monomers to obtain the particles of a latex polymer (A) of the present invention may comprise:
20 to 99 wt.-% of conjugated dienes, preferably selected from 1,3-butadiene, isoprene and combinations thereof, more preferred 1,3-butadiene;
0.05 to 10 wt. % of an ethylenically unsaturated acetoacetoxy and/or acetoacetamido compound (I), preferably an ethylenically unsaturated acetoacetoxy compound (I);
1 to 60 wt.-% of monomers selected from ethylenically unsaturated nitrile compounds, preferably acrylonitrile;
0 to 70 wt.-% of vinyl aromatic monomers, preferably styrene;
0 to 25 wt.-% of C₁ to C₈ alkyl (meth)acrylates;
0 to 10 wt.-%, preferably 0.05 to 7 wt.-% of ethylenically unsaturated acids;
0 to 10 wt.-% of vinyl esters:
wherein the weight percentages are based on the total weight of monomers in the monomer mixture. The ethylenically unsaturated acids may comprise (meth)acrylic acids. Alternatively, the ethylenically unsaturated acids may not comprise (meth)acrylic acid. The amounts of the above-defined monomers for the preparation of latex polymer (A) may add up to 100 wt.-%.

According to the present invention, the particles of a latex polymer (A) may be free of (meth)acrylic acid.

To increase pH stability during transfer and storing, it is advisable to adjust the pH of the polymer latex composition by pH modifiers to be in the range of pH 6.5 to 9.0, preferably 6.5 to 7.0. The pH value of the polymer latex composition may be adjusted using a pH modifier selected from sodium hydroxide, potassium hydroxide, and ammonia solution.

Preferably, the pH value of the polymer latex composition may be adjusted using an ammonia solution.

The particles of a latex polymer (A) may be present in amounts of from 75 to 99.8 wt.-% in the polymer latex composition, such as from 75 to 99.5 wt.-%, or from 75 to 99 wt.-%, or from 75 to 98 wt.-%, or from 75 to 95 wt.-%, or from 78 to 99.8 wt.-%, or from 78 to 99.5 wt.-%, or from 78 to 99 wt.-%, or from 78 to 98 wt.-%, or from 78 to 95 wt.-%, or from 80 to 99.8 wt.-%,or from 80 to 99.5 wt.-%, or from 80 to 99 wt.-%, or from 80 to 98 wt.-%, or from 80 to 95 wt.-%, or from 82 to 99.8 wt.-%, or from 82 to 99.5 wt.-%, or from 82 to 99 wt.-%, or from 82 to 98 wt.-%, or from 82 to 95 wt.-%, or from 85 to 99.8 wt.-%, or from 30 85 to 99.5 wt.-%, or from 85 to 99 wt.-%, or from 85 to 98 wt.-%, or from 85 to 95 wt.-%, or from 90 to 99.8 wt.-%, or from 90 to 99.5 wt.-%, or from 90 to 99 wt.-%, or from 90 to 98 wt.-%, or from 90 to 95 wt.-%, or from 92 to 99.8 wt.-%, or from 92 to 99.5 wt.-%, or from 92 to 99 wt.-%, or from 92 to 98 wt.-%, or from 92 to 95 wt.-%, the weight percentages being based on the total solids weight of the polymer latex composition. Preferably, the particles of a latex polymer (A) may be present in amounts of from 75 to 99.8 wt.-%, more preferably from 78 to 99.5 wt.-%, even more preferably from 80 to 99 wt.-%, most preferably from 82 to 98 wt.-%, the weight percentages being based on the total solids weight of the polymer latex composition.

According to the present invention, the particles of a latex polymer (A) may be pre-crosslinked, preferably partially pre-crosslinked. As used herein, the term “crosslinking” refers to the formation of covalent or coordinate bonds between the particles of a latex polymer. The term “pre-crosslinked” refers to particles of latex polymer being crosslinked prior to being applied to a surface of a substrate and heat treated. Crosslinking reactions may be induced, for example, by exposing the polymer latex composition to heat or radiation, but may also be carried out at ambient conditions. The pre-crosslinked particles to of the polymer latex (A) may comprise further functional groups, such as acetoacetoxy functional groups, acetoacetamido functional groups, carboxylic acid functional groups preferably acetoacetoxy functional groups, that can be further crosslinked. Pre-crosslinking may be obtained by reacting the particles of a latex polymer (A) with a polyamine crosslinker (II) and/or a polyfunctional crosslinker (III). Suitable polyamine crosslinker (II) and suitable polyfunctional crosslinker (III) are those that will be discussed below.

According to the present invention, the particles of the latex polymer (A) may be pre-crosslinked with no more than 5 wt.-%, no more than 4.5 wt.-%, no more than 4 wt.-%, no more than 3.5 wt.-%, no more than 3 wt.-%, no more than 2.5 wt.-%, no more than 20 2 wt.-%, no more than 1.5 wt.-%, no more than 1 wt.-% of a polyamine crosslinker (II), the weight percentage being based on the total weight of the particles of a latex polymer (A). Typically, the particles of the latex polymer (A) may be pre-crosslinked with 0.05 to 5 wt.-%, preferably 0.05 to 4 wt.-%, more preferably 0.1 to 3 wt.-%, even more preferably 0.5 to 2 wt.-% of a polyamine crosslinker (II), the weight percentages being based on the total weight of the particles of a latex polymer (A).

According to the present invention, the particles of the latex polymer (A) may be pre-crosslinked with no more than 5 wt.-%, no more than 4.5 wt.-%, no more than 4 wt.-%, no more than 3.5 wt.-%, no more than 3 wt.-%, no more than 2.5 wt.-%, no more than 2 wt.-%, no more than 1.5 wt.-%, no more than 1 wt.-% of a polyfunctional crosslinker (III), the weight percentage being based on the total weight of the particles of a latex polymer (A). Typically, the particles of the latex polymer (A) may be pre-crosslinked with 0.05 to 5 wt.-%, preferably 0.05 to 4 wt.-%, more preferably 0.1 to 3 wt.-%, even more preferably 0.5 to 2 wt.-% of a polyfunctional crosslinker (III), the weight percentages being based on the total weight of the particles of a latex polymer (A).

The particles of a latex polymer (A) may be crosslinked before or during compounding of the polymer latex composition.

The polymer latex composition may further comprise initiators, antifoams, waxes, surfactants, antioxidants, stabilizers, fillers, pigments, or mixtures thereof. Suitable antifoams may include silicone oils and acetylene glycols. Suitable waxes may include synthetic and/or natural waxes. Natural waxes include montan wax, carnauba wax, bees wax, bayberry-myrtle wax, candelilla wax, caranday wax, castor wax, esparto-grass wax, Japan wax, ouricury wax, shellac, spermaceti, sugar cane wax, wool lanolin and combinations thereof. Synthetic waxes may include paraffin, petroleum jelly, polyethylene to wax, oxidized polyethylene wax, modified polyethylene wax, high density polyethylene wax, oxidized high density polyethylene wax, modified high density polyethylene wax, polypropylene wax, polyamide wax, polytetrafluoroethylene wax, and combinations thereof.

Suitable initiators can be selected from 2,3-dimethyl-2,3-diphenylbutane, tert-butyl hydroperoxide, tert-amyl hydroperoxide, cumyl hydroperoxide, 1,1,3,3-tetramethylbutyl hydroperoxide, isopropylcumyl hydroperoxide, 2,5-di(tert-butylperoxy)-2,5-dimethyl-3-hexyne, 3,6,9-triethyl-3,6,9-trimethyl-1,4,7-triperoxonane, di(tert-butyl)peroxide, 2,5-dimethyl-2,5-di(tert-butylperoxy)hexane, di(tert-butylperoxy-isopropyl)benzene, tert-butyl cumyl peroxide, di-(tert-amyl)-peroxide, dicumyl peroxide, butyl 4,4-di(tert-butylperoxy)valerate, tert-butylperoxybenzoate, 2,2-di(tert-butylperoxy)butane, tert-amyl peroxy-benzoate, tert-butylperoxy-acetate, tert-butylperoxy-(2-ethylhexyl)carbonate, tert-butylperoxy isopropyl carbonate, tert-butyl peroxy-3,5,5-trimethyl-hexanoate, 1,1-di(tert-butylperoxy)cyclohexane, tert-amyl peroxyacetate, tert-amylperoxy-(2-ethylhexyl)carbonate, 1,1-di(tert-butylperoxy)-3,5,5-trimethylcyclohexane, 1,1-di(tert-amylperoxy)cyclohexane, tert-butyl-monoperoxy-maleate, 1,1′-azodi(hexahydrobenzonitrile), tert-butyl peroxy-isobutyrate, tert-butyl peroxydiethylacetate, tert-butyl peroxy-2-ethylhexanoate, dibenzoyl peroxide, tert-amyl peroxy-2-ethylhexanoate, di(4-methylbenzoyl)peroxide, 1,1,3,3-tetramethylbutyl peroxy-2-ethylhexanoate, ammoniumperoxodisulfate, 2,5-dimethyl-2,5-di(2-ethylhexanoylperoxy)hexane, 2,2′-azodi(2-methylbutyronitrile), 2,2′-azodi(isobutyronitrile), didecanoyl peroxide, potassium persulfate, dilauroyl peroxide, di(3,5,5-trimethylhexanoyl) peroxide, tert-amyl peroxypivalate, tert-butyl peroxyneoheptanoate, 1,1,3,3-tetramethylbutyl peroxypivalate, tert-butyl peroxypivalate, dicetyl peroxydicarbonate, dimyristyl peroxydicarbonate, di(2-ethylhexyl) peroxydicarbonate, di(4-tert-butylcyclohexyl) peroxydicarbonate, diisopropyl peroxydicarbonate, tert-butyl peroxyneodecanoate, di-sec-butyl peroxydicarbonate, tert-amyl peroxyneodecanoate, cumyl peroxyneoheptanoate, di(3-methoxybutyl) peroxydicarbonate, 1,1,3,3-tetramethylbutyl peroxyneodecanoate, cumyl peroxyneodecanoate, diisobutyryl peroxide, hydrogen peroxide, and mixture thereof.

Suitable surfactants may include saturated and ethylenically unsaturated sulfonic acids or salts thereof, including, for example, unsaturated hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of acrylic acid and methacrylic acid, such as, for example, sulfoethyl to methacrylate and sulfopropyl methacrylate and salts thereof, and 2-acrylamido-2-methylpropanesulfonic acid and salts thereof; alkylated diphenyl oxide disulfonates, sodium dodecylbenzenesulfonates and dihexyl esters of sodium sulfosuccinate, sodium alkyl esters of sulfonic acid, ethoxylated alkylphenols and ethoxylated alcohols; fatty alcohol (poly)ethersulfates. Suitable antioxidants may include phenolic antioxidants, phosphite antioxidants, alkylated diphenylamine, and the like. Suitable stabilizers may be selected from surfactants, antioxidants, and combinations thereof.

Typically used fillers may include calcium carbonate, clay and silica-based fillers such as fumed silica and precipitated silica. Suitable pigments may include different pigment classes, from colour pigments, phosphorescent pigments, luminous pigments, fluorescence pigments, thermochromic pigments and combinations thereof. Examples of suitable pigments may include sodium silicofluoride, clay, calcium carbonate, silica, mica, animal black, charcoal, lampblack, litharge, lead chromate, white lead, lead carbonate, cadmium yellow, ultramarine, ferric ferrocyanide, vermilion (mercuric sulfide), chlorophyll (green), xantophyll (yellow), carotene, anthocyanin, copper (II) phthalocyanine (Pigments Blue 15:3), 8,18-dichloro-5,15-diethyl-5,15-dihydrodiindolo[3,2-b:3′,2′-m]triphenodioxazine MACROLEX® Fluorescent Red G, MACROLEX® Fluorescent Yellow 1OGN, MACROLEX® Fluorescent Green G Gran, MACROLEX® Fluorescent Violet 3R Gran, MACROLEX® Fluorescent Blue RR Gran, all available from LANXESS Deutschland GmbH (Germany).

The present invention relates to of the polymer latex of the present invention for the production of dip-molded articles, an elastomeric film, a self-supporting elastomeric film or article or for coating or impregnating a substrate, preferably a textile substrate.

### Method for the Preparation of the Polymer Latex of the Present Invention:

The latex polymer (A) according to the present invention can be made by any emulsion polymerization process known to a person skilled in the art, provided that the monomer mixture as herein defined is employed. Particularly suitable is the process as described in EP-A 792 891.

In the emulsion polymerization for preparing the latex polymer (A) of the present invention a seed latex may be employed. Any seed particles as known to the person skilled in the art can be used.

The seed latex particles are preferably present in an amount of 0.01 to 10, preferably 1 to parts by weight, based on 100 parts by weight of total ethylenically unsaturated to monomers employed in the polymer. The lower limit of the amount of seed latex particles therefore can be 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 parts by weight. The upper limit of the amount can be 10, 9, 8, 7, 6, 5.5, 5, 4.5, 4, 3.8, 3.6, 3.4, 3.3, 3.2, 3.1 or 3 parts by weight. A person skilled in the art will understand that any range formed by any of the explicitly disclosed lower limits and upper limits is explicitly encompassed in the present specification.

The process for the preparation of the above-described polymer latex can be performed at temperatures of from 0 to 130° C., preferably of from 0 to 100° C., particularly preferably of from 5 to 70° C., very particularly preferably of from 5 to 60° C., in the presence of no or one or more emulsifiers, no or one or more colloids and one or more initiators. The temperature includes all values and sub-values therebetween, especially including 5, 10, 15, 20, 25, 30, 35, 40, 45, 50, 55, 60, 65, 70, 75, 80, 85, 90, 95, 100, 105, 110, 115, 120 and 125 ° C.

Initiators which can be used when carrying out the present invention include water-soluble and/or oil-soluble initiators which are effective for the purposes of the polymerization. Representative initiators are well known in the technical area and include, for example: azo compounds (such as, for example, AIBN, AMBN and cyanovaleric acid) and inorganic peroxy compounds, such as hydrogen peroxide, sodium, potassium and ammonium peroxydisulfate, peroxycarbonates and peroxyborates, as well as organic peroxy compounds, such as alkyl hydroperoxides, dialkyl peroxides, acyl hydroperoxides, and diacyl peroxides, as well as esters, such as tert-butyl perbenzoate and combinations of inorganic and organic initiators. Suitable initiators may be selected from 2,3-dimethyl-2,3-diphenylbutane, tert-butyl hydroperoxide, tert-amyl hydroperoxide, cumyl hydroperoxide, 1,1,3,3-tetramethylbutyl hydroperoxide, isopropylcumyl hydroperoxide, 2,5-di(tert-butylperoxy)-2,5-dimethyl-3-hexyne, 3,6,9-triethyl-3,6,9-trimethyl-1,4,7-triperoxonane, di(tert-butyl)peroxide, 2,5-dimethyl-2,5-di(tert-butylperoxy)hexane, di(tert-butylperoxy-isopropyl)benzene, tert-butyl cumyl peroxide, di-(tert-amyl)-peroxide, dicumyl peroxide, butyl 4,4-di(tert-butylperoxy)valerate, tert-butylperoxybenzoate, 2,2-di(tert-butylperoxy) butane, tert-amyl peroxy-benzoate, tert-butylperoxy-acetate, tert-butylperoxy-(2-ethylhexyl)carbonate, tert-butylperoxy isopropyl carbonate, tert-butyl peroxy-3,5,5-trimethyl-hexanoate, 1,1-di(tert-butylperoxy)cyclohexane, tert-amyl peroxyacetate, tert-amylperoxy-(2-ethylhexyl)carbonate, 1,1-di(tert-butylperoxy)-3,5,5-trimethylcyclohexane, 1,1-di(tert-amylperoxy)cyclohexane, tert-butyl-monoperoxy-maleate, 1,1′-azodi(hexahydrobenzonitrile), tert-butyl peroxy-isobutyrate, tert-butyl peroxydiethylacetate, tert-butyl peroxy-2-ethylhexanoate, dibenzoyl peroxide, tert-amyl peroxy-2-ethylhexanoate, di(4-methylbenzoyl)peroxide, 1,1,3,3-tetramethylbutyl peroxy-2-ethylhexanoate, ammoniumperoxodisulfate, 2,5-dimethyl-2,5-di(2-ethylhexanoylperoxy)hexane, 2,2′-azodi(2-methylbutyronitrile), 2,2′-azodi(isobutyronitrile), didecanoyl peroxide, potassium persulfate, dilauroyl peroxide, di(3,5,5-trimethylhexanoyl) peroxide, tert-amyl peroxypivalate, tert-butyl peroxyneoheptanoate, 1,1,3,3-tetramethylbutyl peroxypivalate, tert-butyl peroxypivalate, dicetyl peroxydicarbonate, dimyristyl peroxydicarbonate, di(2-ethylhexyl) peroxydicarbonate, di(4-tert-butylcyclohexyl) peroxydicarbonate, diisopropyl peroxydicarbonate, tert-butyl peroxyneodecanoate, di-sec-butyl peroxydicarbonate, tert-amyl peroxyneodecanoate, cumyl peroxyneoheptanoate, di(3-methoxybutyl) peroxydicarbonate, 1,1,3,3-tetramethylbutyl peroxyneodecanoate, cumyl peroxyneodecanoate, diisobutyryl peroxide, hydrogen peroxide, and mixture thereof.

The initiator is used in a sufficient amount to initiate the polymerization reaction at a desired rate. In general, an amount of initiator of from 0.01 to 5 wt.-%, preferably of from 0.1 to 4 wt.-%, based on the total weight of monomers in the monomer mixture, is sufficient. The amount of initiator is most preferably of from 0.01 to 2 wt.-%, based on the total weight of monomers in the monomer mixture. The amount of initiator includes all values and sub-values therebetween, especially including 0.01, 0.1, 0.5, 1, 1.5, 2, 2.5, 3, 4 and 4.5 wt.-%, based on the total weight of monomers in the monomer mixture.

The above-mentioned inorganic and organic peroxy compounds may also be used alone or in combination with one or more suitable reducing agents, as is well known in the art. Examples of such reducing agents may include sulfur dioxide, alkali metal disulfites, alkali metal and ammonium hydrogen sulfites, thiosulfates, dithionites and formaldehyde sulfoxylates, as well as hydroxylamine hydrochloride, hydrazine sulfate, iron (II) sulfate, cuprous naphthanate, glucose, sulfonic acid compounds such as sodium methane sulfonate, amine compounds such as dimethylaniline and ascorbic acid. The quantity of the reducing agent is preferably 0.03 to 10 parts by weight per part by weight of the polymerization initiator.

Surfactants or emulsifiers which are suitable for stabilizing the latex particles include those conventional surface-active agents for polymerization processes. The surfactant or surfactants can be added to the aqueous phase and/or the monomer phase. An effective amount of surfactant in a seed process is the amount which was chosen for supporting the stabilization of the particle as a colloid, the minimization of contact between the particles and the prevention of coagulation. In a non-seeded process, an effective amount of surfactant is the amount which was chosen for influencing the particle size.

Representative surfactants include saturated and ethylenically unsaturated sulfonic acids or salts thereof, including, for example, unsaturated hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of acrylic acid and methacrylic acid, such as, for example, sulfoethyl methacrylate and sulfopropyl methacrylate and salts thereof, and 2-acrylamido-2-methylpropanesulfonic acid and salts thereof; alkylated diphenyl oxide disulfonates, sodium dodecylbenzenesulfonates and dihexyl esters of sodium sulfosuccinate, Sodium alkyl esters of sulfonic acid, ethoxylated alkylphenols and ethoxylated alcohols; fatty alcohol (poly)ethersulfates.

The type and the amount of the surfactant is governed typically by the number of particles, their size and their composition. Typically, the surfactant is used in amounts of from 0 to 20 wt.-%, preferably from 0 to 10 wt.-%, more preferably from 0 to 5 wt.-%, based on the total weight of the monomers in the monomer mixture. The amount of surfactant includes all values and sub-values therebetween, especially including 0, 0.1, 0.5, 1, 2, 3, 4, 5, 6, 7, 8, 9, 10, 11, 12, 13, 14, 15, 16, 17, 18 and 19 wt.-%, based on the total weight of the monomer in the monomer composition. The polymerization may be conducted without using surfactants.

Various protective colloids can also be used instead of or in addition to the surfactants described above. Suitable colloids includepolyhydroxy compounds, such as partially acetylated polyvinyl alcohol, casein, hydroxyethyl starch, carboxymethylcellulose, hydroxyethylcellulose, hydroxypropylcellulose, polysaccharides, and degraded polysaccharides, polyethylene glycol and gum arabic. The preferred protective colloids are carboxymethylcellulose, hydroxyethylcellulose and hydroxypropylcellulose. In general, these protective colloids are used in contents of from 0 to 10 parts by weight, preferably from 0 to 5 parts by weight, more preferably from 0 to 2 parts by weight, based on the total weight of the monomers. The amount of protective colloids includes all values and sub-values therebetween, especially including 1, 2, 3, 4, 5, 6, 7, 8 and 9 wt.-%, based on the total weight of the monomers.

The person skilled in the art will appreciate the type and amounts of monomers bearing polar functional groups, surfactants and protective colloids that are to be selected to make the polymer latex according to the present invention suitable for dip-molding applications. Thus, it is preferred that the polymer latex composition of the present invention has a certain maximum electrolyte stability determined as critical coagulation to concentration of less than 30 mmol/l CaCl₂, preferably less than 25 mmol/l, more preferred less than 20 mmol/l, most preferred less than 10 mmol/l (determined for a total solids content of the composition of 0.1% at pH 10 and 23° C.).

If the electrolyte stability is too high, then it will be difficult to coagulate the polymer latex in a dip-molding process, with the result that either no continuous film of the polymer latex on the immersed mold is formed or the thickness of the resulting product is non-uniform.

It is within the routine of the person skilled in the art to appropriately adjust the electrolyte stability of a polymer latex. The electrolyte stability will depend on certain different factors, for example, amount and selection of monomers to be used for making the polymer latex, especially monomers containing polar-functional groups, as well as the selection and amount of the stabilizing system, for example, the emulsion polymerization process for making the polymer latex. The stabilizing system may contain surface-active agents and/or protective colloids.

A person skilled in the art is able, depending on the selected monomers and their relative amounts for making the polymer latex of the present invention, to adjust the stabilizing system in order to achieve an electrolyte stability according to the present invention.

It is frequently advisable to perform the emulsion polymerization additionally in the presence of buffer substances and chelating agents. Suitable substances are, for example, alkali metal phosphates and pyrophosphates (buffer substances) and the alkali metal salts of ethylenediaminetetraacetic acid (EDTA) or hydroxyl-2-ethylenediaminetriacetic acid (HEEDTA) as chelating agents. The quantity of buffer substances and chelating agents is usually 0.001-1.0 wt.-%, based on the total quantity of monomers.

Furthermore, it may be advantageous to use chain transfer agents (regulators) in emulsion polymerization. Typical agents are, for example, organic sulfur compounds, such as thioesters, 2-mercaptoethanol, 3-mercaptopropionic acid and C₁-C₁₂ alkyl mercaptans, n-dodecylmercaptan and t-dodecylmercaptan being preferred. The quantity of chain transfer agents, if present, is usually 0.05-3.0 wt.-%, preferably 0.2-2.0 wt.-%, based on the total weight of the used monomers.

Furthermore, it can be beneficial to introduce partial neutralization to the polymerization process. A person skilled in the art will appreciate that by appropriate selection of this parameter the necessary control can be achieved.

Various other additives and ingredients can be added in order to prepare the latex composition of the present invention. Such additives include, for example: antifoams, to wetting agents, thickeners, plasticizers, fillers, pigments, dispersants, optical brighteners, crosslinking agents, accelerators, antioxidants, biocides and metal chelating agents. Known antifoams include silicone oils and acetylene glycols. Customary known wetting agents include alkylphenol ethoxylates, alkali metal dialkylsulfosuccinates, acetylene glycols and alkali metal alkylsulfate. Typical thickeners include polyacrylates, polyacrylamides, xanthan gums, modified celluloses or particulate thickeners, such as silicas and clays. Typical plasticizers include mineral oil, liquid polybutenes, liquid polyacrylates and lanolin. Zinc oxide is a suitable crosslinking agent. Titanium dioxide (TiO₂), calcium carbonate and clay are the fillers typically used. Known accelerators and secondary accelerators include dithiocarbamates like zinc diethyl dithiocarbamate, zinc dibutyl dithiocarbamate, zinc dibenyl dithiocarbamate, zinc pentamethylene dithiocarbamate (ZPD), xanthates, thiurams like tetramethylthiuram monosulfide (TMTM), tetramethylthiuram disulfide (TMTD), tetraethylthiuram disulfide (TETD), dipentamethylenethiuram hexasulfide (DPTT), and amines, such as diphenylguanidine (DPG), di-o-tolylguanidine (DOTG), and o-tolylbiguanidine (OTBG).

### Crosslinking Compound (B):

The polymer latex composition may further comprise a crosslinking compound (B). The crosslinking compound (B) may be suitable to react with the acetoacetoxy functional and/or the acetoacetamido functional group of the particles of a latex polymer (A).

The crosslinking compound (B) may be selected from one or more of:
(I) a metal oxide and/or a metal salt;
(II) polyamine crosslinker; and
(III) polyfunctional crosslinker.

Accordingly, the polymer latex composition of the present invention may comprise at least one, such as two or more, or all of:
(I) a metal oxide and/or a metal salt;
(II) polyamine crosslinker; and
(III) polyfunctional crosslinker.

The polymer latex composition may comprise a metal oxide and/or metal salt (I), and a polyamine crosslinker (II) or a polyfunctional crosslinker (III), preferably a polyamine crosslinker (II).

A suitable metal oxide (I) may be selected from divalent, trivalent or tetravalent metal oxides such as zinc oxide, titanium dioxide, magnesium oxide, iron oxide, aluminium oxide, sodium aluminate, sodium stannate, and combinations thereof. A suitable metal to salts (I) may be selected from aluminium sulfate, aluminium chloride, aluminium hydroxide, aluminium nitrate, and combinations thereof.

The metal oxides and/or the metal salt (I) may be present in the polymer latex composition in an amount of from 0.05 to 10 wt.-%, preferably from 0.1 to 8 wt.-%, more preferably from 0.2 to 6 wt.-%, even more preferably from 0.3 to 5 wt.-%, most preferably from 0.5 to 2 wt.-%, based on the total weight of the particles of a latex polymer (A).

Thus, the metal oxide and/or the metal salt (I) may be present in amounts of at least 0.01 wt.-%, at least 0.05 wt.-%, at least 0.1 wt.-%, at least 0.2 wt.-%, at least 0.3 wt.-%, at least 0.4 wt.-%, at least 0.5 wt.-%, at least 0.6 wt.-%, at least 0.7 wt.-%, at least 0.8 wt.-%, at least 0.9 wt.-%, at least 1 wt.-%, at least 1.2 wt.-%, based on the total weight of the particles of a latex polymer (A). Likewise, the metal oxide and/or the metal salt (I) may be present in amounts of no more than 10 wt.-%, no more than 9 wt.-%, no more than 8 wt.-%, no more than 7 wt.-%, no more than 6 wt.-%, no more than 5 wt.-%, no more than 4 wt.-%, no more than 3.5 wt.-%, no more than 3 wt.-%, no more than 2.5 wt.-%, no more than 2 wt.-%, based on the total weight of the particles of a latex polymer (A). A person skilled in the art will appreciate that any range defined by an explicitly disclosed lower limit and an explicitly disclosed upper limit is disclosed herewith.

Herein, the term “polyamine” refers to a compound having more than one amine group per molecule, e.g., 2, 3, 4, 5, 6, or more amine groups per molecule. Suitable polyamine crosslinkers (II) may be selected from 1,2-diamino ethane, 1,6-diamino hexane, phenylene diamine, tris(2-aminoethyl)amine, polyallyl amine, benzidine, branched poly(ethylene imine), and combinations thereof.

The amine groups of the polyamine may react with the acetoacetoxy and/or acetoacetamido compound (I) of the particles of the latex polymer (A) forming an enaminone crosslink. The enaminone crosslink may be thermally reversible. As used herein, the term “thermally reversible” refers to a chemical link between two functional groups that results from a temperature-dependent equilibrium-based chemical reaction wherein the chemical link forms at low temperatures, but is reversibly driven to disruption and rearrangement as the temperature is increased. According to the present invention, a thermally reversible crosslink may be formed at a temperature of or less than 200° C., preferably of or less than 180° C., more preferably of or less than 160° C. Typically, the thermally reversible bond may be formed at a temperature range of 25 to 200° C. According to the present invention, the thermally reversible bond is capable to disrupt at a temperature of or less than 200° C., preferably of or less than 190° C., more preferably of or less than 180° C. and rearrange to form a thermally reversible bond. Typically, the to thermally reversible bond may be capable to disrupt and rearrange at a temperature range of from 25 to 200° C.

The polyamine crosslinker (II) may be present in the polymer latex composition in an amount of from 0.05 to 20 wt.-%, preferably from 0.05 to 17 wt.-%, more preferably from 0.05 to 15 wt.-%, even more preferably from 0.05 to 12 wt.-%, most preferably from 0.05 to 10 wt.-%, based on the total weight of the particles of a latex polymer (A).

Thus, the polyamine crosslinker (II) may be present in amounts of at least 0.01 wt.-%, at least 0.02 wt.-%, at least 0.03 wt.-%, at least 0.04 wt.-%, at least 0.05 wt.-%, at least 0.06 wt.-%, at least 0.07 wt.-%, at least 0.08 wt.-%, at least 0.09 wt.-%, at least 0.1 wt.-%, at least 0.11 wt.-%, at least 0.12 wt.-%, based on the total weight of the particles of a latex polymer (A). Likewise, the polyamine crosslinker (II) may be present in amounts of no more than 20 wt.-%, no more than 19 wt.-%, no more than 18 wt.-%, no more than 17 wt.-%, no more than 16 wt.-%, no more than 15 wt.-%, no more than 14 wt.-%, no more than 13 wt.-%, no more than 12 wt.-%, no more than 10 wt.-%, no more than 8 wt.-%, based on the total weight of the particles of a latex polymer (A). A person skilled in the art will appreciate that any range defined by an explicitly disclosed lower limit and an explicitly disclosed upper limit is disclosed herewith.

Herein, the term “polyfunctional” refers to a compound having at least two functional groups per molecule. The polyfunctional crosslinker (III) may comprise a first functional group reactive with the acetoacetoxy and/or acetoacetamido group of the particles of the latex polymer (A) and a second functional group reactive with the acetoacetoxy and/or acetoacetamido group or a carboxyl group of the particles of the latex polymer (A).

The polyfunctional crosslinker may have the structure

X—R—Y

wherein R is a linear or a branched C₁-C₂₀ alkanediyl, a cyclic C₃-C₂₀ alkyl, alkenyl or arylenediyl; wherein X is a first functional group reactive with the acetoacetoxy and/or acetoacetamido group of the particles of latex polymer (A); and Y is a second functional group reactive with the acetoacetoxy and/or acetoacetamido group or a carboxyl group of the particles of latex polymer (A). Preferably the first functional group (X) is selected from primary amine, secondary amine, hydrazide, isocyanate, or aldehyde. Preferably, the second functional group (Y) is selected from primary amine, secondary amine, aldehyde, epoxy, imine, hydroxyl, hydrazide, hydrazine, isocyanate, or halide. The first functional group (X) and the second functional group (Y) may be the same or different. Preferably, if the first functional group (X) of the polyfunctional amine is a primary amine or a secondary amine, the second functional group (Y) of the polyfunctional amine is not a to primary amine or a secondary amine and vice versa. Accordingly, the first functional group (X) may be selected from primary amine or secondary amine and the second functional group (Y) may be selected from aldehyde, epoxy, imine, hydroxyl, hydrazide, hydrazine, isocyanate, or halide, or the first functional group (X) may be selected from hydrazide, isocyanate, or aldehyde and the second functional group (Y) may be selected from primary amine or secondary amine.

The polyfunctional crosslinker (III) may be selected from polyamines, amino hydrazides, amino aldehydes, alkanolamines, amino halides, polyhydrazides, hydrazide aldehydes, halide hydrazides, polyisocyanates, halide isocyanates, polyaldehydes, hydroxy aldehydes, halide aldehydes, and combinations thereof. Preferably, the polyfunctional crosslinker (III) may be selected from amino hydrazides, amino aldehydes, alkanolamines, amino halides, polyhydrazides, hydrazide aldehydes, halide hydrazides, polyisocyanates, halide isocyanates, polyaldehydes, hydroxy aldehydes, halide aldehydes, and combinations thereof.

Suitable polyamines may be selected from 1,2-diamino ethane, 1,6-diamino hexane, phenylene diamine, tris(2-aminoethyl)amine, polyallyl amine, benzidine and/or branched poly(ethylene imine (PEI), and combinations thereof. Suitable amino hydrazides may be selected from amino benzoic hydrazide, semicarbizide hydrochloride, and combinations thereof. Suitable amino aldehydes may be selected from 2-amino benzaldehyde. Suitable alkanolamines may be selected from methanolamine, ethanolamine, propanolamine, butanolamine, diglycoamine, amino phenol, and combinations thereof. Suitable amino halides may be selected from chloro aniline, methylene-bis(2-chloroaniline), chloro-pyridine-2-carboxylic acid, bromo-pyridine-2-carboxylic acid, iodo-pyridine-2-carboxylic acid and combinations thereof.

Suitable polyhydrazides may be selected from carbohydrazide, adipic acid dihydrazide, sebacic acid hydrazide, isophthalic acid dihydrazide and combinations thereof. Suitable hydrazide aldehydes may be selected from formic hydrazide. Suitable hydroxy hydrazide may be selected from hydroxybenzoic hydrazide. Suitable halide hydrazides may be selected from chlorobenzhydrazide, bromobenzhydrazide, iodobenzhydrazide, and combinations thereof.

Suitable polyisocyanates may be selected from 1,4-diisocyanatobutane, hexamethylene diisocyanate, isophorone diisocyanate, methylene diphenyl diisocyanate, toluene diisocyanate and combinations thereof. Suitable halide isocyanate may be selected from chloroacetyl isocyanate, 4-chlorobenzyl isocyanate, and combinations thereof.

Suitable polyaldehyde may be selected from glyoxyl, glutaraldehyde, phthaldialdehyde, and combinations thereof. Suitable hydroxy aldehyde may be selected from to hydroxybenzaldehyde, syringaldehyde, 4-hydroxy-3-methoxycinnamaldehyde, salicylaldehyde, and combinations thereof. Suitable halide aldehyde may be selected from chloro benzaldehyde, bromo benzaldehyde, iodo benzaldehyde, and combinations thereof.

The polyfunctional crosslinker (III) may be present in the polymer latex composition in an amount of from 0.05 to 20 wt.-%, preferably from 0.05 to 17 wt.-%, more preferably from 0.05 to 15 wt.-%, even more preferably from 0.05 to 12 wt.-%, most preferably from 0.05 to 10 wt.-%, based on the total weight of the particles of a latex polymer (A).

Thus, the polyfunctional crosslinker (III) may be present in amounts of at least 0.01 wt.-%, at least 0.02 wt.-%, at least 0.03 wt.-%, at least 0.04 wt.-%, at least 0.05 wt.-%, at least 0.06 wt.-%, at least 0.07 wt.-%, at least 0.08 wt.-%, at least 0.09 wt.-%, at least 0.1 wt.-%, at least 0.11 wt.-%, at least 0.12 wt.-%, based on the total weight of the particles of a latex polymer (A). Likewise, the polyfunctional crosslinker (III) may be present in amounts of no more than 20 wt.-%, no more than 19 wt.-%, no more than 18 wt.-%, no more than 17 wt.-%, no more than 16 wt.-%, no more than 15 wt.-%, no more than 14 wt.-%, no more than 13 wt.-%, no more than 12 wt.-%, no more than 10 wt.-%, no more than 8 wt.-%, based on the total weight of the particles of a latex polymer (A). A person skilled in the art will appreciate that any range defined by an explicitly disclosed lower limit and an explicitly disclosed upper limit is disclosed herewith.

The crosslinking compound (B) may be present in amounts of from 0.02 to 25 wt.-% in the polymer latex composition, such as from 0.02 to 22 wt.-%, or from 0.02 to 20 wt.-%, or from 0.02 to 18 wt.-%, or from 0.02 to 15 wt.-%, or from 0.02 to 10 wt.-%, or from 0.02 to 8 wt.-%, or from 0.05 to 25 wt.-%, or from 0.05 to 22 wt.-%, or from 0.05 to 20 wt.-%, or from 0.05 to 18 wt.-%, or from 0.05 to 15 wt.-%, or from 0.05 to 10 wt.-%, or from 0.05 to 8 wt.-%, or from 0.2 to 25 wt.-%, or from 0.2 to 22 wt.-%, or from 0.2 to 20 wt.-%, or from 0.2 to 18 wt.-%, or from 0.2 to 15 wt.-%, or from 0.2 to 10 wt.-%, or from 0.2 to 8 wt.-%, or from 0.5 to 25 wt.-%, or from 0.5 to 22 wt.-%, or from 0.5 to 20 wt.-%, or from 0.5 to 18 wt.-%, or from 0.5 to 15 wt.-%, or from 0.5 to 10 wt.-%, or from 0.5 to 8 wt.-%, or from 1.0 to 25 wt.-%, or from 1.0 to 22 wt.-%, or from 1.0 to 20 wt.-%, or from 1.0 to 18 wt.-%, or from 1.0 to 15 wt.-%, or from 1.0 to 10 wt.-%, or from 1.0 to 8 wt.-%, or from 2.0 to 25 wt.-%, or from 2.0 to 22 wt.-%, or from 2.0 to 20 wt.-%, or from 2.0 to 18 wt.-%, or from 2.0 to 15 wt.-%, or from 2.0 to 10 wt.-%, or from 2.0 to 8 wt.-%, or from 5.0 to 25 wt.-%, or from 5.0 to 22 wt.-%, or from 5.0 to 20 wt.-%, or from 5.0 to 18 wt.-%, or from 5.0 to 15 wt.-%, or from 5.0 to 10 wt.-%, or from 5.0 to 8 wt.-%, the weight percentages being based on the total solids weight of the polymer latex composition. Preferably, the to crosslinking compound may be present in amounts of from 0.02 to 25 wt.-% in the polymer latex composition, preferably from 0.05 to 22 wt.-%, more preferably from 0.5 to 20 wt.-%, most preferably 1.0 to 18 wt.-%, the weight percentages being based on the total solids weight of the polymer latex composition.

### Preparation of the Latex Composition

The present invention further relates to a method for preparation of the polymer latex composition of the present invention. The method comprises polymerizing in an emulsion polymerization process a composition comprising a mixture of ethylenically unsaturated monomers comprising a conjugated diene and 0.05 to 20 wt.-% of an ethylenically unsaturated acetoacetoxy and/or acetoacetamido compound (I), the weight percentage of said ethylenically unsaturated acetoacetoxy compound being based on the total weight of monomers in the monomer mixture to obtain particles of a latex polymer (A).

The method for preparation of the polymer latex composition may optionally comprise pre-crosslinking the particles of a latex polymer (A) using 0.05 to 5 wt.-% of a polyamine crosslinker (II) or 0.05 to 5 wt.-% of a polyfunctional crosslinker (III), the weight percentage being based on the total weight of the particles of the latex particles.

Further, the method for preparation of the polymer latex composition may optionally comprise mixing the particles of the latex polymer (A) or the pre-crosslinked particles of the latex polymer (A) with a crosslinking compound (B).

All variations with respect to the latex polymer (A), the crosslinking compound (B) and their relative amounts as described above can be used.

### Compounded Latex Composition for the Production of Dip-Molded Articles:

The polymer latex composition of the present invention is particularly suitable for dip-molding processes. Therefore, according to one aspect of the present invention the polymer latex composition is compounded to produce a curable polymer latex compound composition that can be directly used in dip-molding processes.

To get reproducible good physical film properties, it is advisable to adjust the pH of the compounded polymer latex composition by pH modifiers to be in the range of pH 7 to 11, preferably 8 to 10, more preferred 9 to 10, for dipping to produce thin disposable gloves.

For producing unsupported and/or supported reusable gloves, it is advisable to adjust the pH of the compounded polymer latex composition by pH modifiers to be in the range of pH 8.0 to 12.0, preferably 9.0 to 11.5. The pH value of the compounded polymer latex composition may be adjusted using a pH modifier selected from sodium hydroxide, to potassium hydroxide, and ammonia solution. Preferably, the pH value of the polymer latex composition may be adjusted using potassium hydroxide.

The compounded polymer latex composition contains the polymer latex composition of the present invention, optionally pH modifiers, preferably ammonia or alkali hydroxides and optionally usual additives to be used in these compositions selected from initiators, antioxidants, pigments, TiO₂, fillers, such as silica-based fillers, and dispersing agents.

Suitable silica-based fillers include fumed silica and precipitated silica. Suitable additives are described above.

It is possible to add conventional vulcanization systems to the compounded polymer latex composition according to the present invention to be used in dip-molding processes, such as sulfur in combination with accelerators, such as thiurams and carbamates to make it curable.

However, it is a particular advantage of the present invention that the compounded latex composition of the present invention can be free of sulfur vulcanization agents and accelerators for sulfur vulcanization, and the polymer latex compound of the present invention is still curable to provide dip-molded articles having the required tensile properties. It is preferred to use the crosslinking compound (B) which may be selected from one or more of (I) a metal oxide and/or a metal salt; (II) a polyamine crosslinker; and (III) a polyfunctional crosslinker as described above. Of course, all variations with respect to the latex polymer (A), the crosslinking compound (B) and their relative amounts as described above can be used.

In certain heavy duty applications like industrial gloves it might be advantageous to employ, in addition to the crosslinking compound (B) of the present invention, conventional sulfur vulcanization systems as described above in order to further increase the mechanical strength of the dip-molded articles.

### Method for Making Elastomeric Articles:

The present invention relates to a method for making dip-molded articles. In a suitable method for making dip-molded latex articles, first, a mold having the desired shape of the final article is immersed in a coagulant bath comprising a solution of a metal salt. The coagulant is usually used as a solution in water, an alcohol or a mixture thereof. As specific examples of the coagulant the metal salts can be metal halides like calcium chloride, magnesium chloride, barium chloride, zinc chloride and aluminum chloride; metal nitrates such as calcium nitrate, barium nitrate and zinc nitrate; metal sulfates like calcium sulfate, magnesium sulfate, and aluminum sulfate; and acetic acid salts such as calcium acetate, barium acetate and zinc acetate. Most preferred are calcium chloride to and calcium nitrate. The coagulant solution might contain additives to improve the wetting behavior of the former.

Thereafter, the mold is removed from the bath and optionally dried. The such treated mold is then immersed in the compounded latex composition according to the present invention. Thereby, a thin film of latex is coagulated on the surface of the mold. Alternatively, it is also possible to obtain the latex film by a plurality of dipping steps, particularly two dipping steps in sequence.

Thereafter, the mold is removed from the latex composition and optionally immersed in a water bath in order to extract, for example, polar components from the composition and to wash the coagulated latex film.

Thereafter, the latex coated mold is optionally dried, preferably at temperatures below 80° C.

Finally, the latex coated mold is heat-treated at a temperature of 40 to 200° C. and/or exposed to UV radiation in order to obtain the desired mechanical properties for the final film product. Then, the final latex film is removed from the mold. The duration of the heat treatment will depend on the temperature and is typically between 1 sec and 20 minutes. The higher the temperature, the shorter is the required treatment time. The heat treating may be carried out at a temperature of 60 to 175° C. for 1 sec to 20 min, or at a temperature of 95 to 135° C. for 5 sec to 5 min.

The present invention further relates to a method for the production of a continuous elastomeric film. The method comprises (A) providing a polymer latex composition according to the present invention and (B) forming from the polymer latex composition, preferably an aqueous polymer latex composition, a continuous polymer film. The polymer latex composition may be cast on a substrate at a preselected thickness. Casting can be performed by a conventional film casting machine.

The continuous polymer film obtained in step (B) may optionally be dried, preferably at temperatures below 80° C. (C).

The continuous polymer film obtained in step (B) or (C) is heat-treated at a temperature of 40 to 180° C. and/or exposed to UV radiation in order to obtain the desired mechanical properties for the final film product. The duration of the heat treatment will depend on the temperature and is typically between 1 sec and 20 minutes. The higher the temperature, the shorter is the required treatment time. The heat treating may be carried out at a temperature of 60 to 175° C. for 1 sec to 20 min, or at a temperature of 95 to 135° C. for sec to 5 min. Drying and curing may be performed simultaneously, for example by using radiation heaters. Stripping from the substrate can be done in a powdered or powder-free way.

After stripping, the cured elastomeric film may be rolled into a roll for shipping and further processing. The method may be run as a continuous process with a moving substrate. The substrate is a moving belt which is preferably of a flexible material such as a plastic, preferably a heat resistant plastic such as polytetrafluoroethylene (PTFE) or Teflon. However other material can be used that is capable of providing a support to enable a thin film to be transferred between points in a production process. With this process, very thin films having a thickness lower than usually obtainable in a dip-molding process at a high line speed can be produced. Typically, the line will be operating at a speed where the film is cast at a speed of at least 3 mm per second and typically the speed can be 3-5 mm per second, 3-10 mm or 3 to 20 or up to 3 to 50 mm per second.

Alternatively, the aqueous polymer latex composition of the present invention is treated, preferably by heating or by using a heat sensitizer, to promote coagulation of the latex composition; subsequently the aqueous polymer latex composition is diluted to a preselected solids content that correlates to the preselected thickness of the film, and in step (B) a rotating heated or cooled roll is contacted with the aqueous polymer latex composition to coagulate a polymer film on the roll surface, followed by curing the film, preferably by heating, to form the elastomeric film and stripping the obtained elastomeric film from the roll. Suitable heat sensitizers are known to the person skilled in the art and can be selected from any compound that promotes coagulation of the latex upon temperature change. Suitable heat sensitizers may be selected from polysiloxanes, guanidines or any other type of coagulant that can control the thickness of the film so that a thin film can be formed. By thin film the thickness is typically less than 1 mm, preferably less than 0.5 mm, more preferably less than 0.05 mm and even more preferably less than 0.02 mm. Coagulation can be carried out on a heat resistant surface such as glass or more preferably a ceramic and then the film can be transferred to a flexible support, such as a belt of plastic, e.g., biaxially-oriented polypropylene (BOPP) to enable the coagulated film to be rolled. However, as an alternative coagulation may be carried out on a heat resistant flexible support such as a PTFE or Teflon moving belt where coagulation can occur at one stage of the production process and then once coagulated and formed the film can then be transferred, using the same belt, to a rolling process where the film is rolled into a final roll of material (such a card or steel support roll) for shipping to customers or for storage for processing into final products. For final rolling the film that is formed can be stripped form the support using a powdered or powder-free way and then the cured elastomeric film may be rolled into a roll for shipping and further processing. It is envisaged however that in some circumstances the film can remain on a support surface, which may be a thin plastic layer and then rolled and in this situation the support forms a protective layer which can then be peeled from the film when the film is to be processed.

The present invention further relates to a process for making elastomeric article. In a first step continuous elastomeric films of the polymer latex are made for example by a casting process and optional curing by heating and/or UV curing. In a next stage two separate continuous elastomeric films are aligned and there is then cutting/stamping of the aligned continuous elastomeric films into a preselected shape to obtain two superposed layers of the elastomeric films in the preselected shape. The superposed layers of elastomeric film are joined together at least in a preselected part of the periphery of the superposed layers to form an elastomeric article. The joining together may be performed by using thermal means, preferably selected from heat sealing and welding or by gluing or a combination of heating and gluing.

The cutting may also be performed by a heatable template cutting device providing the preselected shape and the cutting device is heated in the sections that contact the elastomeric films where the films are joined together, thereby simultaneously cutting the elastomeric films into the preselected shape and heat sealing the preselected parts of the periphery of the superposed elastomeric films. Alternatively, a laser cutter may be used. The applied temperature may be in the range of 120° C. to 180° C., preferably 130° C. to 160° C. and more preferably is 160° C. to 190° C. and typically a temperature of 180° C. is used in production. The cutting device is preferably pressed against the superposed elastomeric films with a pressure of at least 1MPa for at least 1 second. If the temperature is higher the pressure used may be less and this is optimized in accordance with the required production speed. Typically, production of 45,000 pieces per hour is required. The cut and seal process can be matched to the production speed on known dipping processes and it also has the advantage that less production space is needed because the length of the line is less in order to avoid the need to drying time during the dipping process. It is also envisaged that a laser cutting of the article shape may be used. If cold laser cutting is used the articles can be cut out for further processing such as sealing or if hot laser cutting is used the articles may be cut and sealed to form the final product. The outline of the article to be produced may be input using a CAD system so that pre-programmed article outlines can be formed for a production run. The use of a laser system has the advantage of avoiding fouling of a stamp used in a press and seal method.

Moreover, the present invention relates to a method for repairing or reforming an to elastomeric film or an article comprising said elastomeric film. The method comprises (a) providing a film or article comprising an elastomeric film or films, having at least two surfaces to be reconnected; (b) re-joining the at least two surfaces of the elastomeric film(s), and (c) heating or annealing the elastomeric film(s) while maintaining intimate contact of the rejoined surfaces of the damaged film at a temperature of 40 to 200° C., preferably 60 to 175° C., more preferably 95 to 135° C. The elastomeric film is made from a polymer latex composition of the present invention and elastomeric film comprises enaminone crosslinks between the particles of the latex polymer (A).

The present invention relates to articles made by using the polymer latex composition of the present invention or the compounded latex composition of the present invention. The articles may be selected from surgical gloves, examination gloves, industrial gloves, household gloves, single-use gloves, textile supported gloves, catheters, elastomeric sleeves, condoms, balloons, tubing, dental dam, apron and pre-formed gasket.

The present invention will be further illustrated with reference to the following examples.

### EXAMPLES

The following abbreviations are used in the Examples:

MAA=methacrylic acid

Bd=butadiene

ACN=acrylonitrile

tDDM=tert-dodecyl mercaptan

Na₄EDTA=tetra sodium salt of ethylenediaminetetraacetic acid

ZnO=zinc oxide

TiO₂=titanium dioxide

TS=tensile strength

EB=elongation at break

FAB=force at break

In the following all parts and percentages are based on weight unless otherwise specified.

### Examples 1A, 1B and 1C

### Preparation of Latex

2 parts by weight (based on polymer solids) of seed latex (average particle size 36 nm) and 80 parts by weight of water (based on 100 parts by weight of monomer including the seed latex) were added to a nitrogen-purged autoclave and subsequently heated to 30° C. Then 0.01 parts by weight of Na₄ EDTA and 0.005 parts by weight of Bruggolite FF6 were dissolved in 2 parts by weight of water were added, followed by 0.08 parts by weight of sodium persulfate dissolved in 2 parts by weight of water. Subsequently, to charging of 57 parts by weight of Bd, 33 parts by weight of ACN, 6 parts by weight of

MAA, 2 parts by weight of 2-(methacryloyloxy)ethyl acetoacetate, 0.88 parts by weight of dodecyl benzene sulfonate (surfactant) and 0.6 parts by weight of tDDM, in the course of 6 hours. Over a period of 10 hours 2.2 parts by weight of sodium dodecyl benzene sulfonate, 0.2 parts by weight of tetra sodium pyrophosphate and 22 parts by weight of water were added. The co-activator feed of 0.13 parts by weight of Bruggolite FF6 in 8 parts by weight of water was added over 9 hours. The temperature was maintained at 30° C. up to a conversion of 95 resulting in a total solids content of 45%. The polymerization was short-stopped by addition of 0.08 parts by weight of a 5% aqueous solution of diethylhydroxylamine. In the first pH adjustment, the pH was adjusted using potassium hydroxide (5% aqueous solution) to at least pH 7.0 and the residual monomers were removed by vacuum distillation at 60° C. 0.5 parts by weight of a Wingstay L type antioxidant (60% dispersion in water) was added to the raw latex, and in the second pH adjustment, the pH was adjusted to at least 8.0 by addition of a 5 aqueous solution of potassium hydroxide.

### Examples 2A, 2B and 2C

### Preparation of Latex

The polymerization is similar to Example 1, but 5 parts by weight of 2-(methacryloyloxy)ethyl acetoacetate and 30 parts by weight of ACN were charged.

### Examples 3A, 3B, 3C, 3D, 3E, 3F and 3G

### Preparation of Latex

The polymerization is similar to Example 1, but the reaction mixture for first pH adjustment was adjusted to at least pH 7.00 using ammonia solution before transfer to stripper and then to storage.

### Example 4A

### Preparation of Latex

The polymerization is similar to Example 1, but 3 parts of MAA and 3 parts by weight of 2-(methacryloyloxy)ethyl acetoacetate were charged, then the reaction mixture for first pH adjustment was adjusted to at least pH 7.00 using ammonia solution before transfer to stripper and then to storage.

### Example 5A

### Preparation of Latex

The polymerization is similar to Example 1, but only 0 parts of MAA and 6 parts by weight of 2-(methacryloyloxy)ethyl acetoacetate were charged then the reaction mixture for first pH adjustment was adjusted to at least pH 7.00 using ammonia solution before transfer to stripper and then to storage.

### Comparative Example 1

### Preparation of Latex

2 parts by weight (based on polymer solids) of seed latex (average particle size 36nm) to and 80 parts by weight of water (based on 100 parts by weight of monomer including the seed latex) were added to a nitrogen-purged autoclave and subsequently heated to 30° C. Then 0.01 parts by weight of Na₄ EDTA and 0.005 parts by weight of Bruggolite FF6 dissolved in 2 parts by weight of water were added, followed by 0.08 parts by weight of sodium persulfate dissolved in 2 parts by weight of water. Subsequently, charging of 57 parts by weight of Bd, 35 parts by weight of ACN, 6 parts by weight of MAA, 0.88 parts by weight of dodecyl benzene sulfonate (surfactant) and 0.6 parts by weight of tDDM, in the course of 6 hours. Over a period of 10 hours 2.2 parts by weight of sodium dodecyl benzene sulfonate, 0.2 parts by weight of tetra sodium pyrophosphate and 22 parts by weight of water were added. The co-activator feed of 0.13 parts by weight of Bruggolite FF6 in 8 parts by weight of water was added over 9 hours. The temperature was maintained at 30° C. up to a conversion of 95 resulting in a total solids content of 45%. The polymerization was short-stopped by addition of 0.08 parts by weight of a 5 aqueous solution of diethylhydroxylamine. In the first pH adjustment, the pH was adjusted using potassium hydroxide (5% aqueous solution) to at least pH 7.0 and the residual monomers were removed by vacuum distillation at 60° C. 0.5 parts by weight of a Wingstay L type antioxidant (60% dispersion in water) was added to the raw latex, and in the second pH adjustment, the pH was adjusted to at least 8.0 by addition of a 5 aqueous solution of potassium hydroxide.

### Comparative Examples 2 and 3

### Preparation of Latex

The polymerization is similar to Comparative Example 1, but the reaction mixture was pH adjusted to at least pH 7.00 using ammonia solution before transfer to stripper and then to storage.

### Preparation of Dipping Latex Examples

Latex Examples were compounded in accordance to Table 1 to 3. The latexes were pH adjusted to pH 10.0 by adding 5% potassium hydroxide solution in water. The compounds were diluted to a total solid content of 18% and matured under continuous stirring at 25° C. for at least 16 hours prior to dipping. Wherein, the accelerator used (if any) is zinc diethyldithiocarbamate.

TABLE 1
Latex compounding formulations and maturation for former dipping

| | Ex. 1A | Ex. 1B | Ex. 1C | Ex. 2A | Ex. 2B | Ex. 2C | CE 1 |
|---|---|---|---|---|---|---|---|
| Latex | 100 | 100 | 100 | 100 | 100 | 100 | 100 |
| ZnO | 1.00 | 1.00 | 1.00 | 1.00 | 1.00 | 1.00 | 1.00 |
| TiO₂ | 1.00 | 1.00 | 1.00 | 1.00 | 1.00 | 1.00 | 1.00 |
| Sulfur | — | — | — | — | — | — | 0.80 |
| Accelerator | — | — | — | — | — | — | 0.70 |
| Ethylene | — | 0.20 | 0.50 | — | 0.50 | 2.00 | — |
| Diamine | | | | | | | |

TABLE 2
Latex compounding formulations and maturation for former dipping

| | Ex. 3A | Ex. 3B | Ex. 3C | Ex. 3D | Ex. 3E | Ex. 3F | Ex. 3G |
|---|---|---|---|---|---|---|---|
| Latex | 100 | 100 | 100 | 100 | 100 | 100 | 100 |
| ZnO | 1.00 | 1.00 | 1.00 | 1.00 | 1.00 | 1.00 | 1.00 |
| TiO₂ | 1.00 | 1.00 | 1.00 | 1.00 | 1.00 | 1.00 | 1.00 |
| Sulfur | — | — | — | — | — | — | — |
| Accelerator | — | — | — | — | — | — | — |
| Ethylene | — | 0.35 | 0.50 | — | — | — | — |
| Diamine | | | | | | | |
| Hexamethylene | — | — | — | 0.68 | — | — | — |
| Diamine | | | | | | | |
| Phenylene | — | — | — | — | 0.57 | — | — |
| Diamine | | | | | | | |
| Tris(2- | — | — | — | — | — | 0.50 | — |
| aminoethyl) | | | | | | | |
| amine | | | | | | | |
| Polyethylene- | — | — | — | — | — | — | 10.90 |
| imine | | | | | | | |

TABLE 3
Latex compounding formulations and
maturation for former dipping

| | Ex. 4A | Ex. 5A | CE 2 | CE 3 |
|---|---|---|---|---|
| Latex | 100 | 100 | 100 | 100 |
| ZnO | 1.00 | 1.00 | 1.00 | 1.00 |
| TiO₂ | 1.00 | 1.00 | 1.00 | 1.00 |
| Sulfur | | | — | 0.80 |
| Accelerator | | | — | 0.70 |
| Ethylene Diamine | 0.20 | 0.20 | 0.20 | — |
| Hexamethylene | — | — | — | — |
| Diamine | | | | |
| Phenylene Diamine | — | — | — | — |
| Tris(2-aminoethyl)amine | — | — | — | — |
| Polyethylene-imine | — | — | — | — |

### Dipping Procedure

Dipping was conducted manually or using automatic dipping machine. A dipping mold is conditioned in an air circulated oven at 70° C., then dipped into a coagulant solution comprising of 18-20 wt. % aqueous solution of calcium nitrate and 2-3 wt. % of calcium carbonate at 60° C. for 1 second. The dipping mold is then placed in an oven set at 75-85° C. for a certain time then dipped into respective latexes at dipping plate mold temperature of 60-65° C. for a set time to obtain a latex-dipped plate mold. The latex-dipped former was then gelled in the oven for 1 minute at 100° C. and leached into DI to water leaching tank for 1 minute at 50-60° C. follow by curing in the oven at 120° C. for 20 minutes. Finally, a cured latex is manually stripped from the plate mold. The cured latexes were conditioned in the climate room at 23° C. (±2) at 50% (±5) relative humidity for at least 16 hours before other physical tests.

### Determination of Tensile Properties (ASTM D6319 and EN 455)

The tensile properties of the final films were tested according to ASTM D6319 and EN455 test procedures. Dumbbell specimens were cut from films prepared from each latex compound; the Unaged and Aged samples (“aged” refers to specimens which are placed in an oven for 22 hours at 100° C. before tensile properties are tested) were conditioned at 23±2° C. and 50±5% relative humidity for 24 hours prior to testing on the extensometer. The film thickness (mm) was measured with a typical film thickness value between 0.060-0.070 mm. The reported tensile strength (TS) corresponds to the determined maximum tensile stress in stretching the specimen to rupture. The elongation at break (EB) corresponds to the elongation at which rupture occurs. The force at break corresponds to the force at which rupture occurs. While Modulus 100, 300 and 500 (M100, M300 and M500) corresponds to the determined tensile stress in stretching the specimen at 100, 300 and 500% elongation. Meanwhile, the reported force at break (FAB) corresponds to the determined maximum tensile force in stretching the specimen to rupture.

The tensile data for the as-prepared films described above were measured and summarized in Tables 4 to 7. Tables 4 and 6 show the unaged results and Tables 5 and 7 show the aged results.

TABLE 4
Unaged results

| | ASTM D6319 | | | | | | EN 455 | |
|---|---|---|---|---|---|---|---|---|
| | Thick- | | | | | | Thick- | |
| | ness | TS | EB | Modulus | | | ness | FAB |
| Sample | (mm) | (MPa) | (%) | 100 | 300 | 500 | (mm) | (N) |
| Ex. 1A | 0.063 | 27.0 | 532 | 2.9 | 6.7 | 20.1 | 0.060 | 7.0 |
| Ex. 1B | 0.067 | 26.8 | 511 | 3.3 | 7.7 | 22.0 | 0.063 | 6.6 |
| Ex. 1C | 0.065 | 25.1 | 480 | 4.4 | 8.4 | | 0.063 | 6.4 |
| Ex. 2A | 0.065 | 23.5 | 624 | 2.3 | 4.7 | 10.8 | 0.067 | 6.5 |
| Ex. 2B | 0.067 | 21.6 | 466 | 3.1 | 7.8 | | 0.065 | 6.0 |
| Ex. 2C | 0.067 | 24.8 | 429 | 3.8 | 9.8 | | 0.068 | 5.7 |
| CE 1 | 0.067 | 30.0 | 539 | 2.6 | 5.9 | 21.6 | 0.066 | 7.2 |

TABLE 5
Aged results

| | ASTM D6319 | | | | | | EN 455 | |
|---|---|---|---|---|---|---|---|---|
| | Thick- | | | | | | Thick- | |
| | ness | TS | EB | Modulus | | | ness | FAB |
| Sample | (mm) | (MPa) | (%) | 100 | 300 | 500 | (mm) | (N) |
| Ex. 1A | 0.065 | 31.1 | 554 | 3.0 | 7.0 | 21.9 | 0.065 | 7.6 |
| Ex. 1B | 0.066 | 30.5 | 503 | 3.7 | 8.9 | 29.6 | 0.064 | 7.1 |
| Ex. 1C | 0.067 | 28.8 | 478 | 3.9 | 9.4 | | 0.064 | 7.3 |
| Ex. 2A | 0.064 | 26.8 | 626 | 2.5 | 5.2 | 12.1 | 0.067 | 7.1 |
| Ex. 2B | 0.069 | 26.4 | 477 | 3.3 | 8.2 | | 0.069 | 7.1 |
| Ex. 2C | 0.068 | 30.6 | 461 | 3.9 | 9.9 | | 0.068 | 7.1 |
| CE 1 | 0.064 | 34.0 | 510 | 3.4 | 8.2 | 31.7 | 0.068 | 8.1 |

TABLE 6
Unaged results

| | ASTM D6319 | | | | | | EN 455 | |
|---|---|---|---|---|---|---|---|---|
| | Thick- | | | | | | Thick- | |
| | ness | TS | EB | Modulus | | | ness | FAB |
| Sample | (mm) | (MPa) | (%) | 100 | 300 | 500 | (mm) | (N) |
| Ex. 3A | 0.055 | 30.5 | 536 | 3.3 | 7.4 | 23.6 | 0.058 | 6.8 |
| Ex. 3B | 0.051 | 30.8 | 539 | 3.6 | 8.3 | 24.4 | 0.050 | 4.8 |
| Ex. 3C | 0.062 | 24.8 | 501 | 3.3 | 7.8 | 20.0 | 0.062 | 6.4 |
| Ex. 3D | 0.054 | 30.0 | 500 | 3.7 | 9.0 | 25.9 | 0.051 | 5.0 |
| Ex. 3E | 0.053 | 30.9 | 580 | 2.5 | 6.1 | 17.7 | 0.052 | 5.6 |
| Ex. 3F | 0.050 | 29.5 | 581 | 2.5 | 5.8 | 15.1 | 0.050 | 3.4 |
| Ex. 3G | Coagulated (no dipping conducted) | | | | | | | |
| Ex. 4A | 0.070 | 18.1 | 671 | 2.1 | 3.9 | 7.0 | 0.063 | 5.8 |
| Ex. 5A | 0.082 | 3.3 | 777 | 0.7 | 1.0 | 1.2 | 0.086 | 1.0 |
| CE 2 | 0.062 | 34.1 | 609 | 2.7 | 5.4 | 14.1 | 0.058 | 7.8 |
| CE 3 | 0.058 | 33.1 | 459 | 3.6 | 9.8 | | 0.061 | 7.7 |

TABLE 7
Aged results

| | ASTM D6319 | | | | | | EN 455 | |
|---|---|---|---|---|---|---|---|---|
| | Thick- | | | | | | Thick- | |
| | ness | TS | EB | Modulus | | | ness | FAB |
| Sample | (mm) | (MPa) | (%) | 100 | 300 | 500 | (mm) | (N) |
| Ex. 3A | 0.061 | 32.2 | 543 | 3.1 | 7.2 | 23.6 | 0.060 | 7.1 |
| Ex. 3B | 0.050 | 34.5 | 507 | 3.6 | 9.1 | 31.1 | 0.049 | 6.2 |
| Ex. 3C | 0.063 | 29.3 | 492 | 3.5 | 8.9 | | 0.064 | 7.6 |
| Ex. 3D | 0.055 | 34.8 | 498 | 3.7 | 9.5 | | 0.055 | 6.0 |
| Ex. 3E | 0.053 | 33.0 | 582 | 2.4 | 5.3 | 17.4 | 0.052 | 6.1 |
| Ex. 3F | 0.053 | 36.0 | 523 | 3.1 | 7.8 | 30.6 | 0.050 | 6.1 |
| Ex. 3G | Coagulated (no dipping conducted) | | | | | | | |
| Ex. 4A | 0.074 | 28.1 | 645 | 2.4 | 5.0 | 9.9 | 0.072 | 7.9 |
| Ex. 5A | 0.078 | 5.4 | 787 | 0.8 | 1.2 | 1.7 | 0.084 | 2.0 |
| CE 2 | 0.064 | 41.8 | 576 | 3.3 | 7.4 | 25.5 | 0.063 | 8.8 |
| CE 3 | 0.063 | 35.9 | 418 | 4.8 | 14.3 | | 0.066 | 7.2 |

Shown in Table 1, comparative Example 1 (CE1) uses a conventional curing package containing sulfur and accelerator. Whereas, Ex. 1A, 1B, 1C, 2A, 2B and 2C are sulfur, accelerator-free cured latex containing ZnO crosslinkers, with or without ethylene diamine, a polyamine crosslinker. For Unaged and Aged samples, the tensile properties of ZnO crosslinked latex (Ex. 1A and 2A) are comparable to CE1, but slightly lower TS albeit with a slight improvement in EB. The addition of polyamine crosslinkers (Examples 1B and 2B) gave comparable TS to CE1, but the EB have dropped slightly. Further increasing the polyamine crosslinker amount (Examples 1C and 2C), show further reduction in EB.

Shown in Table 3, Comparative Example 2 (CE2), is a sulfur, accelerator-free cured latex containing polyamine as crosslinker. Whereas, Comparative Example 3 (CE3) uses a conventional curing package containing sulfur and accelerator. Ex. 3A, 3B, 3C, 3D, 3E, 3F and 3G are sulfur, accelerator-free latex containing ZnO crosslinkers, with various polyamine crosslinkers (ethylene diamine, hexamethylenediamine, phenylenediamine, to tris(2-aminoethyl)amine and polyethylene imine) of varying content. In Ex. 3A, 3B and 3C, the first pH adjustment using ammonia solution improves the tensile properties. In Ex. 4A, 3 parts by weight of MAA is replaced with 3 parts by weight of 2-(methacryloyloxy)ethyl acetoacetate, crosslinked with ZnO and polyamine gave comparable tensile performance to CE3. In another Ex. 5A, all 6 parts by weight of MAA is replaced completely with 6 parts by weight of 2-(methacryloyloxy)ethyl acetoacetate further crosslinked with ZnO and polyamine produces latex film.

TABLE 8
Stress relaxation times

Stress relaxation time (seconds)

| Sample | 75° C. | 95° C. | 105° C. | 115° C. | 135° C. |
|---|---|---|---|---|---|
| Ex. 1A | 209 | 66 | 54 | 15 | 12 |
| Ex. 1B | N.A. | 97 | 50 | 32 | 21 |
| Ex. 1C | N.A. | 252 | 100 | 99 | 59 |
| Ex. 3A | 209 | 66 | 32 | 12 | 5 |
| Ex. 3C | N.A. | 146 | 67 | 41 | 16 |

| | |
|---|---|
| CE 1 | N.A. |
| CE 3 | N.A. |

N.A.: Unable to achieve 1/e of initial stress within 1200 sec

The stress relaxation time of some selected samples containing 2-(methacryloyloxy)ethyl acetoacetate (Ex. 1A, 1B, 1C, 3A and 3C) all have faster stress relaxation time in comparison to CE1 and CE3. Latexes containing 2-(methacryloyloxy)ethyl acetoacetate crosslinked with ZnO and polyamine, contain thermally-reversible enaminone-based cross-linkages. These thermally-reversible cross-linkages dissociate faster with increasing temperature. due to lower polymer network stability at high temperature. Both CE1 and CE3 failed to achieve 1/e of initial stress within 1200 s due to highly thermo-stable sulfur crosslinks which are not thermally-reversible.

1. A polymer latex composition for producing an elastomeric film comprising:
particles of a latex polymer (A) obtained by free-radical emulsion polymerization of a mixture of ethylenically unsaturated monomers comprising a conjugated diene and 0.05 to 20 wt.-% of an ethylenically unsaturated acetoacetoxy and/or acetoacetamido compound (I), wherein the weight percentage of the ethylenically unsaturated acetoacetoxy and/or acetoacetamido compound (I) is based on the total weight of the monomers in the monomer mixture.

2. The polymer latex composition of claim 1, further comprising a crosslinking compound (B).

3. The polymer latex composition of claim 1, wherein the ethylenically unsaturated acetoacetoxy and/or acetoacetamido compound (I) has the following structure: 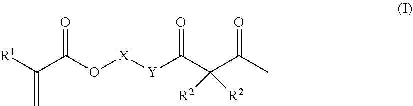
wherein R¹ is selected from hydrogen, or a hydrocarbyl group such as methyl;
wherein X is a linear or a branched C₁-C₂₀ alkanediyl, a cyclic C₃-C₂₀ alkyl, alkenyl or arylenediyl;
wherein Y is O or NH;
wherein each R² independently is a hydrogen or a hydrocarbyl group.

4. The polymer latex composition of claim 2, wherein the crosslinking compound is selected from one or more of:
(I) a metal oxide and/or a metal salt,
(II) polyamine crosslinker, and
(III) polyfunctional crosslinker, having the structure
X—R—Y
wherein R is a linear or a branched C₁-C₂₀ alkanediyl, a cyclic C₃-C₂₀ alkyl, alkenyl or arylenediyl;
wherein X is a first functional group reactive with the acetoacetoxy and/or acetoacetamido group of the particles of latex polymer (A) and Y is a second functional group reactive with the acetoacetoxy and/or acetoacetamido group or a carboxyl group of the particles of latex polymer (A);
wherein the weight percentages are based on the total weight of the polymer latex (A),
wherein the particles of latex polymer (A) are present in amounts of 75 to 99.8 wt.-%, wherein the weight percentages are based on the total solids weight of the polymer latex composition.

5. The polymer latex composition of claim 1, wherein
the monomer composition for the latex polymer (A) further comprises
(a) 15 to 99 wt.-% of conjugated dienes;
(b) 1 to 80 wt.-% of monomers selected from ethylenically unsaturated nitrile compounds;
(c) 0 to 10 wt.-% of an ethylenically unsaturated acrylic acid and/or salts thereof,
(d) 0 to 80 wt.-% of vinyl aromatic monomers; and
(e) 0 to 65 wt.-% of alkyl esters of ethylenically unsaturated acids,
wherein the weight percentages are based on the total weight of monomers in the monomer mixture.

6. The polymer latex composition of claim 1, wherein the mixture of ethylenically unsaturated monomers for latex polymer comprises:
20 to 99 wt.-% of conjugated dienes;
0.05 to 10 wt.-% of an ethylenically unsaturated acetoacetoxy and/or acetoacetamido compound (I);
1 to 60 wt.-% of monomers selected from ethylenically unsaturated nitrile compounds;
0 to 70 wt.-% of vinyl aromatic monomers;
0 to 25 wt.-% of C₁ to C₈ alkyl (meth)acrylates;
0 to 10 wt.-%, preferably 0.05 to 7 wt.-% of ethylenically unsaturated acids;
0 to 10 wt.-% of vinyl esters:
wherein the weight percentages are based on the total weight of monomers in the monomer mixture.

7. The polymer latex composition of claim 1, wherein the particles of a latex polymer (A) are free of (meth)acrylic acid; and/or
wherein the pH value of the polymer latex composition is from 6.5 to 9.0; and/or
wherein the polymer latex composition further comprises initiators, antifoams, waxes, surfactants, antioxidants, stabilizers, fillers, pigments or combinations thereof; and/or
wherein the particles of the latex polymer (A) are pre-crosslinked obtained by reacting the particles of a latex polymer with 0.05 to 5 wt.-% of a polyamine crosslinker (II) or 0.05 to 5 wt.-% of a polyfunctional crosslinker (III), wherein the weight percentages are based on the total weight of the particles of a latex polymer (A).

8. A compounded polymer latex composition suitable for the production of dip-molded articles comprising the polymer latex composition of claim 1, wherein the polymer latex composition further comprises adjuvants selected from sulfur vulcanization agents, accelerators for sulfur vulcanization and combinations thereof or the polymer latex composition is free of sulfur vulcanization agents and accelerators for sulfur vulcanization.

9. A method for the preparation of the polymer latex composition of claim 1, comprising:
a) polymerizing in an emulsion polymerization process a composition comprising a mixture of ethylenically unsaturated monomers comprising a conjugated diene and 0.05 to 20 wt.-% of an ethylenically unsaturated acetoacetoxy and/or acetoacetamido compound (I), wherein the weight percentage of the ethylenically unsaturated acetoacetoxy and/or acetoacetamido compound (I) is based on the total weight of monomers in the monomer mixture to obtain particles of a latex polymer (A),
b) optionally pre-crosslinking the particles of a latex polymer (A) using 0.05 to 5 wt.-% of a polyamine crosslinker (II) or 0.05 to 5 wt.-% of a polyfunctional crosslinker (III), wherein the weight percentage is based on the total weight of the particles of the latex polymer (A);
c) optionally mixing the particles of a latex polymer (A) with a crosslinking compound (B).

10. Use of the polymer latex composition of claim 1 for the production of dip-molded articles, an elastomeric film, a self-supporting elastomeric film or article or for coating or impregnating a substrate.

11. A method for making dip-molded articles by a) providing a compounded polymer latex composition of claim 8;
b) immersing a mold having the desired shape of the final article in a coagulant bath comprising a solution of a metal salt;
c) removing the mold from the coagulant bath and optionally drying the mold;
d) immersing the mold as treated in step b) and c) in the compounded latex composition of step a);
e) coagulating a latex film on the surface of the mold;
f) removing the latex-coated mold from the compounded latex composition and optionally immersing the latex-coated mold in a water bath;
g) optionally drying the latex-coated mold;
h) heat treating the latex-coated mold obtained from step e) or f) at a temperature of 40° C. to 200° C.; and/or UV treating; and
i) removing the latex article from the mold.

12. A method for the production of a continuous elastomeric film comprising:
(A) providing a polymer latex composition as defined or prepared in claim 1;
(B) forming from the polymer latex composition a continuous polymer film;
(C) optionally drying the continuous polymer film obtained in step B);
(D) heat treating the continuous polymer film obtained in step B) or C) at a temperature of 40° C. to 180° C. to form a continuous elastomeric film; and/or UV treating, and
(E) optionally rolling the continuous elastomeric film obtained in step D) into a roll.

13. A process for making an elastomeric article by
aligning two separate continuous elastomeric films obtained according to claim 11;
cutting the aligned continuous elastomeric films into a preselected shape to obtain two superposed layers of the elastomeric films in the preselected shape; and
joining together the superposed layers of elastomeric film at least a preselected part of the periphery of the superposed layers to form an elastomeric article;
wherein the joining together preferably is performed by using thermal means.

14. A method for repairing or reforming an elastomeric film or an article comprising said elastomeric film by
a) providing a film or article comprising an elastomeric film or films, having at least two surfaces to be reconnected,
b) re-joining the at least two surfaces of the elastomeric film(s), and
c) heating or annealing the elastomeric film(s) while maintaining intimate contact of the rejoined surfaces of the damaged film at a temperature of 40 to 200° C., wherein
the elastomeric film is made from a polymer latex composition as defined in claim 1, wherein the elastomeric film comprises enaminone crosslinks between the particles of the latex polymer.

15. An article made by using the polymer latex composition according claim 1.
